(19) United States
(12) Patent Application Publication
(10) Pub. No.: US 2026/0230217 A1
(43) Pub. Date: Aug. 6, 2026

(54) CONTROLLING METHOD AND APPARATUSES

(71) Applicant: Huawei Technologies Co., Ltd., Shenzhen (CN)

(72) Inventors: Qifan Zhang, Ottawa (CA); Yiqun Ge, Ottawa (CA); Jianglei Ma, Ottawa (CA); Huazi Zhang, Zhejiang (CN); Wuxian Shi, Ottawa (CA); Wen Tong, Ottawa (CA)

(21) Appl. No.: 19/565,136

(22) Filed: Mar. 12, 2026

Related U.S. Application Data
(63) Continuation of application No. PCT/CN2024/074280, filed on Jan. 26, 2024.
(60) Provisional application No. 63/582,289, filed on Sep. 13, 2023.

(51) Int. Cl. H04L 1/00; G06F 40/30; G06F 40/40

(52) U.S. Cl. CPC H04L 1/0009; G06F 40/30; G06F 40/40

(57) ABSTRACT

Provided are a controlling method and related apparatuses. The method includes: generating, by using a language model (LM), a controlling message in natural language; obtaining, according to the controlling message, semantic information of the controlling message; forming an information payload when the semantic information of the controlling message is relevant to one or more pieces of multiple pieces of semantic information, where the multiple pieces of semantic information correspond to multiple function modalities that have been registered to the LM, and a part or all of the multiple pieces of semantic information is obtained from at least one user device, and where the information payload includes the semantic information of the controlling message; sending the information payload.

### CROSS-REFERENCE TO RELATED APPLICATIONS

This application is a continuation of International Application No. PCT/CN2024/074280, filed on Jan. 26, 2024, which claims priority to U.S. Provisional Application No. 63/582,289, filed on Sep. 13, 2023, all of which are incorporated herein by reference in their entirety.

### TECHNICAL FIELD

The present invention relates to the field of wireless communication technologies, and in particular, to a controlling method and an apparatus, a device, a system and a storage medium.

### BACKGROUND

Communication can be divided into three levels: bit communication(s), semantic communication(s), and effectiveness communication(s). In the past 60 years, wireless communication has focused on the level of bit communication, the lowest level, which is called as a “technical problem” to ensure an absolute accuracy of bits transmitted from a transmitter to a receiver. Effectiveness communication, as the highest level, was proposed to achieve an ultimate goal of communications, which is called as an “effectiveness problem” to ensure a success of conveying a semantic meaning to the receiver leads to the desired conduct on the receiver side.

This background information is provided to reveal information believed by the applicant to be of possible relevance to the present disclosure. No admission is necessarily intended, nor should be construed, that any of the preceding information constitutes prior art against the present disclosure.

### SUMMARY

In a first aspect, an embodiment of the present disclosure provides a controlling method, where the method includes:
generating, by using a language model (LM), a controlling message in natural language;
obtaining, according to the controlling message, semantic information of the controlling message;
forming an information payload when the semantic information of the controlling message is relevant to one or more pieces of multiple pieces of semantic information, where the multiple pieces of semantic information correspond to multiple function modalities that have been registered to the LM, and a part or all of the multiple pieces of semantic information is obtained from at least one user device, and where the information payload includes the semantic information of the controlling message;
sending the information payload.

A central device generates a controlling message in natural language, and when the semantic information of the controlling message is relevant to one or more pieces of multiple pieces of semantic information, the central device forms an information payload including semantic information of the controlling message to control a user device. In this way, an open vocabulary can be supported in controlling, more effective and flexible communication can be achieved, backward and forward compatibility can be supported, and cross-modality functionality can be accommodated. In addition, since the central device obtains a part or all of the multiple pieces of semantic information from at least one user device, the central device don't need to know the description(s) of corresponding function modalities and transform the description(s) to semantic information, and therefore, which can protect customer's privacy and commercial intellectual property.

In a possible implementation of the first aspect, the LM may be a language learning model (LLM).

In a possible implementation of the first aspect, the method further includes:
obtaining registering information of a function modality, where the registering information includes one or more pieces of semantic information of the function modality, where the function modality belongs to the multiple function modalities.

In a possible implementation of the first aspect, the one or more pieces semantic information of the function modality include a piece of semantic information obtained from a description of the function modality, where the description of the function modality is in natural language. Since the user device can transmit the registering information including a piece of semantic information associated with a function modality to the central device, rather than transmitting the description of the function modality to the central device, the function modality is black box for the central device, thereby protecting customer's privacy and commercial intellectual property.

In a possible implementation of the first aspect, the one or more pieces of semantic information of the function modality further include at least one piece of semantic information relevant to a result of the function modality, where the at least one piece of semantic information relevant to the result of the function modality is obtained from at least one description relevant to the result of the function modality and the at least one description relevant to the result of the function modality is in natural language. Since the one or more pieces of semantic information of the function modality may further include at least one piece of semantic information relevant to a result of the function modality, more complex and sophisticated control of wireless devices can be supported.

In a possible implementation of the first aspect, the registering information of the function modality further includes a list of arguments of the function modality.

Since the registering information of a function modality includes semantic information of the function modality or further includes semantic information relevant to a result of the function modality and/or a list of arguments of the function modality, the system can accommodate cross-modality functionality and support backward and forward compatibility, and when new function modalities are added, they can be registered with the semantic information associated with the new function modalities without requiring changes to the system architecture or communication protocols, which improves the universality of the system, and makes the system more flexible.

In a possible implementation of the first aspect, the method further includes: recording the registering information of the function modality. After obtaining the registering information, it can be stored locally for further use, thereby facilitating further maintenance.

In a possible implementation of the first aspect, the method further includes: recording information indicative of a user device identifier (ID) or a group user device ID of a user device from which the registering information of the function modality is received. The central device may record information indicative a user device ID of a user device or information indicative a group user device ID of a user device group together with the registering information for further use, to call respective function modalities of different user devices more directly without the need for additional communication or negotiation, thereby helping optimize the utilization of transmission resources.

In a possible implementation of the first aspect, the method further includes:
rejecting the controlling message, when the relevance between the semantic information of the controlling message and each of the multiple pieces of semantic information is lower than a threshold.

The central device would determine a relevance between the semantic information of the controlling message and each of the multiple pieces of semantic information associated with the function modality that has been registered, to determine whether the controlling message is a registered one. When the relevance between the semantic information of the controlling message and the semantic information associated with the function modality registered is lower than a threshold, it can be determined that the controlling message is not registered, and the central device would reject the non-registered controlling message. The central device may not need to encode or transmit the non-registered controlling message and the central device may multicast or unicast the controlling message to only those user devices that have registered for the corresponding function modality, thereby saving the central device's and user device's power, and saving transmission resources.

In a possible implementation of the first aspect, the controlling message indicates an action to be executed.

In a possible implementation of the first aspect, the controlling message further indicates information related to execution of the action indicated by the controlling message.

In a possible implementation of the first aspect, the controlling message is a conditional controlling message or a looping controlling message.

Since the controlling message generated by the central device can be a conditional controlling message or a looping controlling message, the controlling message in a natural language that supports conditionality and/or looping is introduced in the system, which helps improve efficiency and flexibility of the communication system.

In a possible implementation of the first aspect, the information related to the execution of the action is based on a result of another action indicated by the controlling message. Since the controlling message may include the information related to the execution of the action, which is based on a result of another action indicated by the controlling message, the controlling message can indicate the action to be executed and a basis or condition for the execution of the action to a user device through a single controlling message. Compared with a traditional process in which the user device needs to report an action result to the central device and then the central device instructs, based on the action result, the user device to execute the next action, a communication process for controlling can be simplified, and more complex and sophisticated control of wireless devices can be allowed.

In a possible implementation of the first aspect, the multiple pieces of semantic information corresponding to the multiple function modalities that have been registered to the LM include multiple pieces of first semantic information each corresponding to a respective function modality in the multiple function modalities and obtained from a description of the respective function modality in the multiple function modalities.

In a possible implementation of the first aspect, the multiple pieces of semantic information corresponding to the multiple function modalities further include at least one piece of second semantic information each obtained from a description relevant to a result of a function modality in the multiple function modalities.

In a possible implementation of the first aspect, the obtaining, according to the controlling message, the semantic information of the controlling message includes:
determining, from the controlling message, a portion without any arguments;
obtaining, by using an embedder, and according to the portion, the semantic information of the controlling message.

The generated controlling message may include a list of arguments (values), and the central device may divide the controlling message into two portions: a first portion including the list of arguments if any and a second portion including the rest part of the controlling message, and the central device only translate the second portion into the semantic information. Since the arguments (values), which may vary, are not included in the second portion translated to the semantic information, the semantic information of the controlling message can be highly relevant to the semantic information of the corresponding function modality, thereby facilitating the central device to determine whether the controlling message is a registered one, and facilitating the user device to determine a corresponding function modality, and meanwhile, reducing the computational complexity and facilitating standardizing the length of the semantic information.

In a possible implementation of the first aspect, the forming the information payload includes:
forming a first information payload, where the first information payload includes starting position information of a second transmission opportunity and length information of the semantic information of the controlling message; and
forming a second information payload, where the second information payload includes the semantic information of the controlling message, and where the second transmission opportunity is for transmission of the second information payload information.

The central device may form a first information payload and a second information payload to transmit the controlling message, which allows for more efficient use of radio resources and provides greater flexibility in terms of error correction and retransmission. Since the starting position information of the second transmission opportunity and the length information of the semantic information are included in the first information payload, the receiving device can synchronize and correctly receive the second information payload.

In a possible implementation of the first aspect, the controlling message further includes a list of arguments, and the first information payload further includes the list of arguments of the controlling message.

In a possible implementation of the first aspect, the method further includes:
encoding the second information payload by using a first encoding method;
where the first information payload further includes information of the first encoding method.

By including the first encoding method used to encode the second information payload in the first information payload, the user device can immediately identify the appropriate coding scheme required to decode the subsequent second information payload.

In a possible implementation of the first aspect, the method further includes: encoding the first information payload by using a second encoding method.

In a possible implementation of the first aspect, the first encoding method includes a first modulation and coding scheme (MCS), and the second encoding method includes a second MCS.

In a possible implementation of the first aspect, the method further includes:
determining, from the multiple pieces of semantic information corresponding to the multiple function modalities that have been registered, and according to the relevance between the semantic information of the controlling message and each of the multiple pieces of semantic information corresponding to the multiple function modalities that have been registered, one or more pieces of semantic information most relevant to the semantic information of the controlling message; and
determining at least one user device ID or at least one group user device ID corresponding to the one or more pieces of most relevant semantic information;
where the first information payload further includes: the at least one user device ID, or at least one group user device ID; or the first information payload further includes information indicative of the at least one user device ID or information indicative of the at least one group user device ID.

The central device can determine the specific function modality that the controlling message is targeted to, and determine a corresponding user device or group user device that the controlling message is sent to, which ensures that the controlling message is delivered to the intended recipients, improving the efficiency and accuracy of the communication system. What's more, since the user device ID or the group user device ID, or the information indicative of the user device ID or information indicative of the group user device ID is included in the first information payload, the receiving user device can determine whether it is a correct recipient according to the first information payload, thereby improving the efficiency and accuracy of the communication system, and when the receiving user device is not an intended recipient, the user device may stop decoding the second information payload, thereby saving the energy of the user device.

In a possible implementation of the first aspect, the sending the information payload includes:
sending the first information payload during a first transmission opportunity; and
sending the second information payload during the second transmission opportunity.

The central device may send the first information payload and the second information payload during the first transmission opportunity and the second transmission opportunity respectively. Thus the central device can allocate the radio resource more effectively by assigning different transmission opportunities to each payload, and can help prevent congestion and ensure that the information is transmitted smoothly.

In a possible implementation of the first aspect, the method further includes: sending configuration information of at least one embedder.

In a possible implementation of the first aspect, the configuration information of the at least one embedder is sent via a broadcast message, a multicast message, or a unicast message.

There may be one or more embedders, and different embedders may be built on different domains, specialization on the vocabulary can greatly reduce the size and cost of the embedder but also improve the accuracy of the relevance computation.

In a possible implementation of the first aspect, the configuration information of the at least one embedder includes an architecture and parameters of each of the at least one embedder.

In a possible implementation of the first aspect, the configuration information of the at least one embedder further includes an embedder ID of each of the at least one embedder.

The configuration information of the embedder may include an architecture and parameters of each embedder, and the configuration information of the embedder may further include an embedder ID of each embedder, which facilitates the configuration of each embedder to the user device.

In a possible implementation of the first aspect, the information payload is sent via a multicast message or a unicast message.

In a second aspect, an embodiment of the present disclosure provides a controlling method, where the method includes:
obtaining an information payload, where the information payload includes semantic information of a controlling message, where the semantic information of the controlling message is relevant to one or more pieces of semantic information in multiple pieces of semantic information, and the multiple pieces of semantic information correspond to multiple function modalities that have been registered to a language model (LM) generating the controlling message, and a part or all of the multiple pieces of semantic information is obtained from at least one user device;
determining, according to the semantic information of the controlling message, and from multiple pieces of candidate semantic information, target semantic information, where the multiple pieces of candidate semantic information correspond to multiple function modalities that are supported by a user device, and the target semantic information indicates a function modality to be executed, and the multiple function modalities that are supported by the user device includes the function modality to be executed; and
executing, according to the target semantic information, the function modality to be executed.

A user device may obtain an information payload including semantic information of a controlling message where the controlling message indicates a respective action to be executed, and the user device may determine at least one piece of target semantic information based on the controlling message, and may execute the corresponding function modality. In this way, an open vocabulary can be supported in controlling, more effective and flexible communication can be achieved, backward and forward compatibility can be supported, and cross-modality functionality can be accommodated. In addition, since a part or all of the multiple pieces of semantic information is obtained from at least one user device, the central device don't need to know the description(s) of corresponding function modalities and transform the description(s) to semantic information, and therefore, which can protect customer's privacy and commercial intellectual property.

In a possible implementation of the second aspect, the LM may be a language learning model (LLM)

In a possible implementation of the second aspect, the method further includes:
sending multiple pieces of registering information of the multiple function modalities, where at least one piece of registering information each includes one or more pieces of semantic information of a corresponding function modality, where the multiple pieces of registering information include the at least one piece of registering information.

In a possible implementation of the second aspect, the one or more pieces of semantic information of the corresponding function modality include a piece of semantic information obtained from a description of the corresponding function modality, where the description of the corresponding function modality is in natural language.

By sending multiple pieces of registering information of multiple function modalities, the multiple function modalities can be registered. In this way, the system can accommodate the cross-modality functionality and support backward and forward compatibility. When the registering information of a function modality can include a piece of semantic information associated with a function modality, rather than the description of the function modality, the function modality is a black box for the central device, thereby protecting customer's privacy and commercial intellectual property.

In a possible implementation of the second aspect, the one or more pieces of semantic information of the corresponding function modality further include at least one piece of semantic information relevant to a result of the corresponding function modality, where the at least one piece of semantic information relevant to the result of the corresponding function modality is obtained from at least one description relevant to the result of the corresponding function modality, and the at least one description relevant to the result of the function modality is in natural language. Since the one or more pieces of semantic information of the function modality may further include at least one piece of semantic information relevant to a result of the function modality, more complex and sophisticated control of wireless devices can be supported.

In a possible implementation of the second aspect, each of one or more pieces of registering information includes a list of arguments of a corresponding function modality, where the multiple pieces of registering information include the one or more pieces of registering information.

Since the registering information of a function modality includes semantic information of the function modality or further includes semantic information relevant to a result of the function modality and/or a list of arguments of the function modality, the system can accommodate the cross-modality functionality and support backward and forward compatibility, and when new function modalities are added, they can be registered with the semantic information associated with the new function modalities without requiring changes to the system architecture or communication protocols, which improves the universality of the system, and makes the system more flexible.

In a possible implementation of the second aspect, the determining, according to the semantic information of the controlling message, and from multiple pieces of candidate semantic information, target semantic information includes:
determining, from the multiple pieces of candidate semantic information, at least one piece of candidate semantic information most relevant to the semantic information of the controlling message as the target semantic information.

In a possible implementation of the second aspect, the target semantic information further indicates information related to execution of the function modality.

In a possible implementation of the second aspect, the controlling message is a conditional controlling message or a looping controlling message.

Since the controlling message generated by the central device can be a conditional controlling message or a looping controlling message, the controlling message in a natural language that supports conditionality and looping is introduced in the system, which helps improve efficiency and flexibility of the communication system.

In a possible implementation of the second aspect, the information related to the execution of the function modality is based on a result of another function modality as indicated by the controlling message. Since the controlling message may include the information related to the execution of the action, which is based on a result of another action indicated by the controlling message, the controlling message can indicate the action to be executed and a basis or condition for the execution of the action to a user device through a single controlling message. Compared with a traditional process in which the user device needs to report an action result to the central device and then the central device instructs, based on the action result, the user device to execute the next action, a communication process for controlling can be simplified, and more complex and sophisticated control of wireless devices can be allowed.

In a possible implementation of the second aspect, the method further includes:
encapsulating each of the multiple function modalities that are supported by the user device in a calling function to obtain multiple calling functions, where each of the multiple calling functions includes a description of a respective function modality, where the description is in natural language.

In a possible implementation of the second aspect, one or more calling functions of the multiple calling functions each further include at least one of: a list of arguments of the respective function modality or at least one description relevant to a result of the respective function modality, where the at least one description relevant to the result of the function modality is in natural language, and includes a conditional description describing a condition on the result of the respective function modality, or a looping description describing a loop with a condition on the result of the respective function modality.

In a possible implementation of the second aspect, the calling function includes an application programming interface (API) calling function.

Since each function modality can be encapsulated into a calling function, such as the API calling function, the calling function can be called to execute the function modality. The calling function can be implemented in various programming languages, by encapsulating each function modality of the multiple function modalities into a calling function, it becomes easier to integrate and use with different programming languages, and promote interoperability between different systems or components that may be developed using different technologies.

In a possible implementation of the second aspect, the method further includes: obtaining configuration information of at least one embedder. Through the configuration information of at least one embedder, the at least one embedder can be configured to the user device and then the user device can use the at least one embedder to translate the description of the function modality to semantic information.

In a possible implementation of the second aspect, the configuration information of the at least one embedder includes an architecture and parameters of each of the at least one embedder.

In a possible implementation of the second aspect, the configuration information of the at least one embedder further includes an embedder ID of each of the at least one embedder.

Through the configuration information of at least one embedder, the at least one embedder can be configured to the user device and then the user device can use the at least one embedder to translate the description of the function modality to semantic information.

In a possible implementation of the second aspect, the method further includes:
obtaining, by using the at least one embedder, one or more pieces of semantic information for each function modality of the multiple function modalities that are supported by the user device; and
storing the one or more pieces of semantic information.

The user device may use each of the at least one embedder to obtain one or more pieces of semantic information for each of the at least one function modality, and may store the obtained semantic information, which enables the user device to access and utilize the semantic information when needed quickly.

In a possible implementation of the second aspect, the one or more pieces of semantic information for each function modality includes a piece of semantic information obtained from a description of each function modality.

In a possible implementation of the second aspect, the one or more pieces of semantic information for each of one or more function modalities further includes at least one piece of semantic information obtained from at least one description relevant to a result of a corresponding function modality, where the multiple function modalities includes the one or more function modalities.

In a possible implementation of the second aspect, the method further includes decoding the information payload.

In a possible implementation of the second aspect, the information payload includes:
a first information payload, obtained during a first transmission opportunity, and including starting position information of a second transmission opportunity and length information of the semantic information of the controlling message; and
a second information payload, obtained during the second transmission opportunity, and including the semantic information of the controlling message.

In a possible implementation of the second aspect, the decoding the information payload includes:
decoding the first information payload to obtain the starting position information of the second transmission opportunity and the length information of the semantic information of the controlling message; and
decoding the second information payload to obtain the semantic information of the controlling message.

The user device may obtain the first information payload and the second information payload during the first transmission opportunity and the second transmission opportunity respectively. Thus the radio resource can be allocated more effectively by assigning different transmission opportunities to each payload, and the process of obtaining and decoding the information payload ensures the reliable retrieval of the semantic information of the controlling message.

In a possible implementation of the second aspect, the first information payload further includes: a list of arguments of the controlling message.

In a possible implementation of the second aspect, the first information payload further includes information of a first encoding method, and the second information payload is decoded by using the first encoding method. By including the first encoding method used to encode the second information payload in the first information payload, the user device can immediately identify the appropriate coding scheme required to decode the subsequent second information payload.

In a possible implementation of the second aspect, the first information payload is decoded by using a second encoding method.

In a possible implementation of the second aspect, the first encoding method includes a first modulation and coding scheme (MCS), and the second encoding method include a second MCS.

In a possible implementation of the second aspect, the first information payload further includes information indicative of the embedder ID of a first embedder, and the method further includes:
obtaining, from the stored one or more pieces of semantic information and according to the information indicative of the embedder ID of the first embedder, the multiple pieces of candidate semantic information.

In a possible implementation of the second aspect, where the first information payload further includes: information indicative of a user device ID or information indicative of a group user device ID.

In a possible implementation of the second aspect, the method further includes:
in response to determining that the user device ID or the group user device ID does not match a user device ID or a group user device ID of the user device, refraining from decoding the second information payload.

Since the information indicative of the user device ID or information indicative of the group user device ID is included in the first information payload, the user device can determine whether it is a correct recipient according to the first information payload, thereby improving the efficiency and accuracy of the communication system.

In a third aspect, an embodiment of the present disclosure provides a first apparatus including various modules configured to execute the controlling method according to the first aspect or any possible implementation of the first aspect.

In a fourth aspect, an embodiment of the present disclosure provides a second apparatus including various modules configured to execute the controlling method according to the second aspect or any possible implementation of the second aspect.

In a fifth aspect, an embodiment of the present disclosure provides a third apparatus including processing circuitry for executing the controlling method according to the first aspect or any possible implementation of the first aspect.

In a sixth aspect, an embodiment of the present disclosure provides a fourth apparatus including processing circuitry for executing the controlling method according to the second aspect or any possible implementation of the second aspect.

In a seventh aspect, an embodiment of the present disclosure provides a communication system, including a first apparatus according to the third aspect or a third apparatus according to the fifth aspect, and a second apparatus according to the fourth aspect or a fourth apparatus according to the sixth aspect.

In an eighth aspect, an embodiment of the present disclosure provides a computer-readable medium storing computer execution instructions which, when executed by a processor, causes the processor to execute the controlling method according to the first aspect or any possible implementation of the first aspect or according to the second aspect or any possible implementation of the second aspect.

In a ninth aspect, an embodiment of the present disclosure provides a computer program product including computer execution instructions which, when executed by a processor, causes the processor to execute the controlling method according to the first aspect or any possible implementation of the first aspect or according to the second aspect or any possible implementation of the second aspect.

The present disclosure provides a controlling method and related apparatuses. A controlling message in natural language is generated by using an LM; semantic information of the controlling message is obtained according to the controlling message; an information payload is formed when the semantic information of the controlling message is relevant to one or more pieces of multiple pieces of semantic information, where the multiple pieces of semantic information correspond to multiple function modalities that have been registered to the LM, and a part or all of the multiple pieces of semantic information is obtained from at least one user device, and where the information payload includes the semantic information of the controlling message; and then the information payload is sent. In this way, an open vocabulary can be supported in controlling, more effective and flexible communication can be achieved, backward and forward compatibility can be supported, cross-modality functionality can be accommodated, and customer's privacy and commercial intellectual property can also be protected.

### BRIEF DESCRIPTION OF THE DRAWINGS

Reference will now be made, by way of example, to the accompanying drawings which show example embodiments of the present disclosure, and in which:

FIG. 1 is a simplified schematic illustration of a communication system according to one or more embodiments of the present disclosure.

FIG. 2 is a schematic illustration of an example communication system according to one or more embodiments of the present disclosure.

FIG. 3 is a schematic illustration of a basic component structure of a communication system according to one or more embodiments of the present disclosure.

FIG. 4 illustrates a block diagram of a device in a communication system according to one or more embodiments of the present disclosure.

FIG. 5 is a schematic diagram of a communication system.

FIG. 6 is a schematic diagram showing communications between a central device and a first user device.

FIG. 7 is a schematic diagram of a LLM model according one or more embodiments of the present disclosure.

FIG. 8 shows a schematic flowchart of a controlling method according to one or more example embodiments of the present disclosure.

FIG. 9 shows a schematic flowchart of a controlling method according to one or more example embodiments of the present disclosure.

FIG. 10 shows a schematic flowchart of a registering process according to one or more embodiments of the present disclosure.

FIG. 11 is a schematic diagram of a central device according one or more embodiments of the present disclosure.

FIG. 12 is a schematic diagram of configuration of an embedder according one or more embodiments of the present disclosure.

FIG. 13 is a schematic diagram of a function modality according one or more embodiments of the present disclosure.

FIG. 14 is a schematic diagram of a function modality according one or more embodiments of the present disclosure.

FIG. 15 is a schematic diagram of an example of obtaining a semantic vector according one or more embodiments of the present disclosure.

FIG. 16 is a schematic diagram of an example of informing a central device of registering information of a function modality by a user device according one or more embodiments of the present disclosure.

FIG. 17 is a schematic diagram of an example of registering a function modality by a central device according one or more embodiments of the present disclosure.

FIG. 18 is a schematic diagram of an example of recording a second user device by a central device according one or more embodiments of the present disclosure.

FIG. 19 is a schematic diagram of an example of generating a controlling message according one or more embodiments of the present disclosure.

FIG. 20 is a schematic diagram of an example of a relevance comparing process according one or more embodiments of the present disclosure.

FIG. 21 is a schematic diagram of an example of encoding and transmitting an open-voc controlling message in two transmission opportunity by a central device according one or more embodiments of the present disclosure.

FIG. 22 is a schematic diagram of an example of decoding and receiving an open-voc controlling message in two transmission opportunity by a user device according one or more embodiments of the present disclosure.

FIG. 23 is a schematic diagram of an example of executing process by a user device according one or more embodiments of the present disclosure.

FIG. 24 is a schematic diagram of another function modality according one or more embodiments of the present disclosure.

FIG. 25 is a schematic diagram of an example of obtaining semantic vectors according one or more embodiments of the present disclosure.

FIG. 26 is a schematic diagram of another example of informing a central device of registering information of a function modality by a user device according one or more embodiments of the present disclosure.

FIG. 27 is a schematic diagram of another example of registering a function modality by a central device according one or more embodiments of the present disclosure.

FIG. 28 is a schematic diagram of an example of executing process by a user device according one or more embodiments of the present disclosure.

FIG. 29 is a schematic diagram of an example of informing a central device of registering information of a function modality by a user device according one or more embodiments of the present disclosure.

FIG. 30 is a schematic diagram of an example of recording a first user device by a central device according one or more embodiments of the present disclosure.

FIG. 31 shows a schematic structural diagram of a first apparatus according to one or more example embodiments of the present disclosure.

FIG. 32 shows a schematic structural diagram of a second apparatus according to one or more example embodiments of the present disclosure.

### DETAILED DESCRIPTION OF THE ILLUSTRATIVE EMBODIMENTS

To describe the technical solutions in embodiments of the present invention or in the prior art more clearly, the following briefly introduces the accompanying drawings needed for describing the embodiments or the prior art.

In the following description, reference is made to the accompanying figures, which form part of the present disclosure, and which show, by way of illustration, specific aspects of embodiments of the present disclosure or specific aspects in which embodiments of the present disclosure may be used. It is understood that embodiments of the present disclosure may be used in other aspects and include structural or logical changes not depicted in the figures. The following detailed description, therefore, is not to be taken in a limiting sense, and the scope of the present disclosure is defined by the appended claims.

To describe the technical solutions in embodiments of the present invention or in the prior art more clearly, the following briefly introduces the accompanying drawings needed for describing the embodiments or the prior art.

Communication can be divided into three levels: bit communication(s), semantic communication(s), and effectiveness communication(s). In the past 60 years, wireless communication has focused on the level of bit communication, the lowest level, which is called as a “technical problem” to ensure an absolute accuracy of bits transmitted from a transmitter to a receiver. Effectiveness communication, as the highest level, was proposed to achieve an ultimate goal of communications, which is called as an “effectiveness problem” to ensure a success of conveying a semantic meaning to the receiver leads to the desired conduct on the receiver side.

Wireless communication system heavily relies on pre-negotiated (standardized) contents and formats of controlling messages, which may cause backward and/or forward compatibility issue among different communication system.

For illustrative purposes, specific example embodiments will now be explained in greater detail in conjunction with the figures.

The embodiments set forth herein represent information sufficient to practice and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device/apparatus or accessible or connectable thereto. Computer/processor readable/executable instructions to implement a method, an application or a module described herein may be stored or otherwise held by such non-transitory computer/processor readable storage media.

Further, in the disclosure, the word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context. The term “and/or” herein when used in association with a list of items means any one or more of the items comprising that list.

A two-stage controlling messaging system method, and apparatus for a wireless system is provided in this disclosure. The wireless system contains one center device (also called central device, e.g., one apparatus such as a base station, a core network) and at least one user device (e.g., another apparatus such as a UE). In the following, the scenario in which the center device transmits some controlling messages to the user device is taken as an example. Please note that, the scenario in which the user device transmits some controlling messages to the center device could be included in the same way in this disclosure.

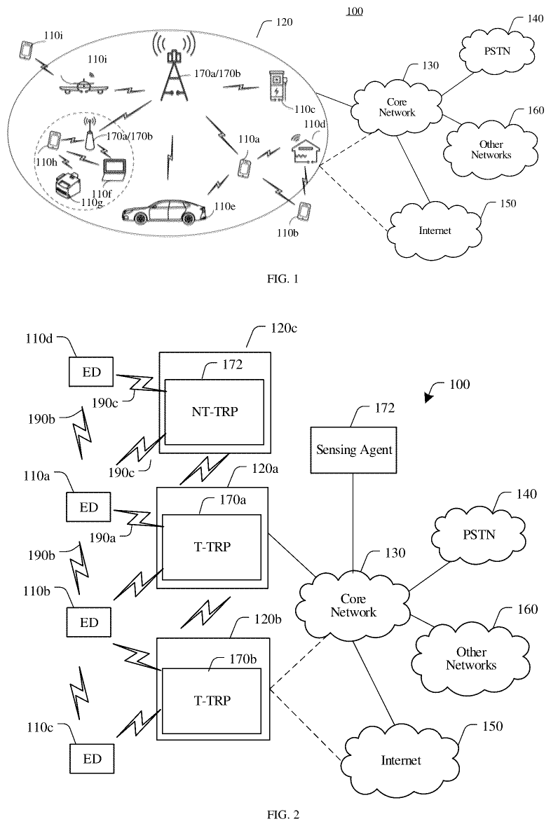

FIG. 1 is a simplified schematic illustration of a communication system according to one or more embodiments of the present disclosure.

Referring to FIG. 1, as an illustrative example without limitation, a simplified schematic illustration of a communication system is provided. The communication system 100 (which may be the wireless system in FIG. 1) comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

The uplink messages/data transmitted between the central device (e.g., the network node 170) and the sensing device (e.g., ED 180) could be carried in higher layer signaling, such as RRC signaling, or MAC layer signaling. Or, they could be carried in physical layer signaling, e.g., UCI. Or they could be carried in the combination of the higher layer signaling and the physical signaling. It could be noted that the message in the present disclosure could be replaced with information, which may be carried in one single message, or be carried in more than one separate message. The downlink messages/data transmitted between the central device and the ED 110 could be carried in higher layer signaling, such as RRC signaling, or MAC layer signaling. Or, they could be carried in physical layer signaling, e.g., UCI. Or they could be carried in the combination of the higher layer signaling and the physical signaling. It could be noted that the message in the present disclosure could be replaced with information, which may be carried in one single message, or be carried in more than one separate message.

Custom network power savings implementations can be considered where an operator performs power saving manually based on heuristics, traffic load management and balancing.

FIG. 2 is a schematic illustration of an example communication system according to one or more embodiments of the present disclosure.

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast, groupcast, unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150, and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172. As may be surmised on the basis of similarity in reference numerals, the non-terrestrial communication network 120c may be considered to be a radio access network, with operational aspects in common with the RANs 120a, 120b. The non-terrestrial communication network 120c may include at least one non-terrestrial network (NTN) device and at least one corresponding terrestrial network device, wherein the at least one non-terrestrial network device works as a transport layer device and the at least one corresponding terrestrial network device works as a radio access network node, which communicates with the ED via the non-terrestrial network device.

Any ED 110 may be alternatively or additionally configured to interface, access, or communicate with any T-TRP 170a,170b and NT-TRP 172, the Internet 150, the core network 130, the PSTN 140, the other networks 160, or any combination of the preceding. In some examples, ED 110a may communicate an uplink and/or downlink transmission over a terrestrial air interface 190a with T-TRP 170a. In some examples, the EDs 110a, 110b, 110c, and 110d may also communicate directly with one another via one or more sidelink air interfaces 190b. In some examples, ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA, also known as discrete Fourier transform spread OFDMA, DFT-s-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 172 for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the Internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the Internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers to support such.

FIG. 3 is a schematic illustration of a basic component structure of a communication system according to one or more example embodiments of the present disclosure.

FIG. 3 illustrates another example of an ED 110 and a base station 170a, 170b and/or 170c. The ED 110 is used to connect persons, objects, machines, etc. The ED 110 may be widely used in various scenarios including, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, wearable devices (such as a watch, a pair of glasses, head mounted equipment, etc.), an industrial device, or an apparatus in (e.g. communication module, modem, or chip) or comprising the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated to avoid congestion in the drawing. One, some, or all of the antennas 204 may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 1). The input/output devices or interfaces permit interaction with a user or other devices in the network. Each input/output device or interface includes any suitable structure for providing information to or receiving information from a user, and/or for network interface communications. Suitable structures include, for example, a speaker, microphone, keypad, keyboard, display, touch screen, etc.

The ED 110 includes the processor 210 for performing operations including those operations related to preparing a transmission for uplink transmission to the NT-TRP 172 and/or the T-TRP 170; those operations related to processing downlink transmissions received from the NT-TRP 172 and/or the T-TRP 170; and those operations related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g. beam angle information (BAI), received from the T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201, and the processing components of the receiver 203 may each be implemented by the same or different one or more processors that are configured to execute instructions stored in a memory (e.g. in the memory 208). Alternatively, some or all of the processor 210, the processing components of the transmitter 201, and the processing components of the receiver 203 may each be implemented using dedicated circuitry, such as a programmed field-programmable gate array (FPGA), an application-specific integrated circuit (ASIC), or a hardware accelerator such as a graphics processing unit (GPU) or an artificial intelligence (AI) accelerator.

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g. a communication module, a modem, or a chip) in the forgoing devices.

In some embodiments, the parts of the T-TRP 170 may be distributed. For example, some of the modules of the T-TRP 170 may be located remote from the equipment that houses the antennas 256 for the T-TRP 170, and may be coupled to the equipment that houses the antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses the antennas 256 of the T-TRP 170. The modules may also be coupled to other T-TRPs. In some embodiments, the T-TRP 170 may actually be a plurality of T-TRPs that are operating together to serve the ED 110, e.g. through the use of coordinated multipoint transmissions.

The T-TRP 170 includes at least one transmitter 252 and at least one receiver 254 coupled to one or more antennas 256. Only one antenna 256 is illustrated to avoid congestion in the drawing. One, some, or all of the antennas 256 may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to the NT-TRP 172, and processing a transmission received over backhaul from the NT-TRP 172. Processing operations related to preparing a transmission for downlink or backhaul transmission may include operations such as encoding, modulating, precoding (e.g. multiple input multiple output (MIMO) precoding), transmit beamforming, and generating symbols for transmission. Processing operations related to processing received transmissions in the uplink or over backhaul may include operations such as receive beamforming, demodulating received symbols, and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates an indication of beam direction, e.g. BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Signaling may be transmitted in a physical layer control channel, e.g. a physical downlink control channel (PDCCH), in which case the signaling may be known as dynamic signaling. Signaling transmitted in a downlink physical layer control channel may be known as Downlink Control Information (DCI). Signaling transmitted in an uplink physical layer control channel may be known as Uplink Control Information (UCI). Signaling transmitted in a sidelink physical layer control channel may be known as Sidelink Control Information (SCI). Signaling may be included in a higher-layer (e.g., higher than physical layer) packet transmitted in a physical layer data channel, e.g. in a physical downlink shared channel (PDSCH), in which case the signaling may be known as higher-layer signaling, static signaling, or semi-static signaling. Higher-layer signaling may also refer to Radio Resource Control (RRC) protocol signaling or Media Access Control - Control Element (MAC-CE) signaling.

The scheduler 253 may be coupled to the processor 260. The scheduler 253 may be included within or operated separately from the T-TRP 170. The scheduler 253 may schedule uplink, downlink, sidelink, and/or backhaul transmissions, including issuing scheduling grants and/or configuring scheduling-free (e.g., “configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252, and the processing components of the receiver 254 may each be implemented by the same or different one or more processors that are configured to execute instructions stored in a memory, e.g. in the memory 258. Alternatively, some or all of the processor 260, the scheduler 253, the processing components of the transmitter 252, and the processing components of the receiver 254 may be implemented using dedicated circuitry, such as a programmed FPGA, a hardware accelerator (e.g., a GPU or AI accelerator), or an ASIC.

Although the NT-TRP 172 is illustrated as a drone only as an example, the NT-TRP 172 may be implemented in any suitable non-terrestrial form, such as satellites and high altitude platforms, including international mobile telecommunication base stations and unmanned aerial vehicles, for example. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated to avoid congestion in the drawing. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating received symbols, and decoding received symbols. In some embodiments, the processor 276 implements the transmit beamforming and/or receive beamforming based on beam direction information (e.g. BAI) received from the T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272, and the processing components of the receiver 274 may each be implemented by the same or different one or more processors that are configured to execute instructions stored in a memory, e.g. in the memory 278. Alternatively, some or all of the processor 276, the processing components of the transmitter 272, and the processing components of the receiver 274 may be implemented using dedicated circuitry, such as a programmed FPGA, a hardware accelerator (e.g., a GPU or AI accelerator), or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

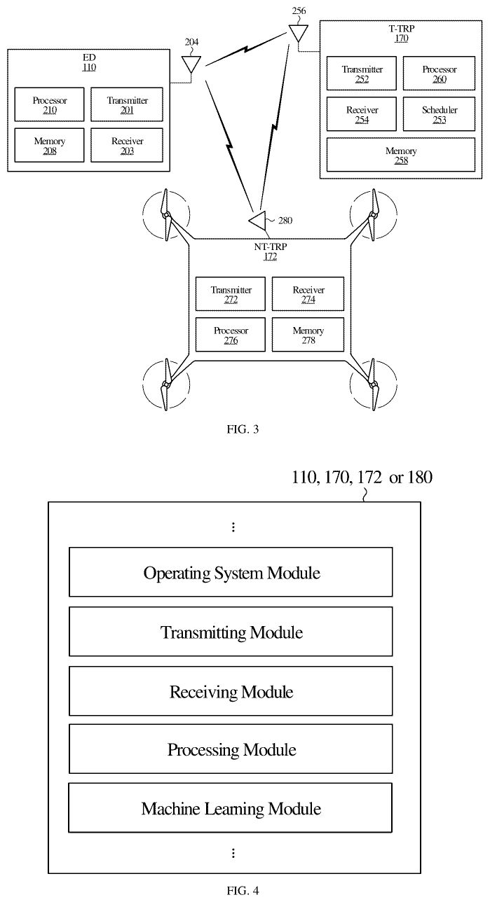

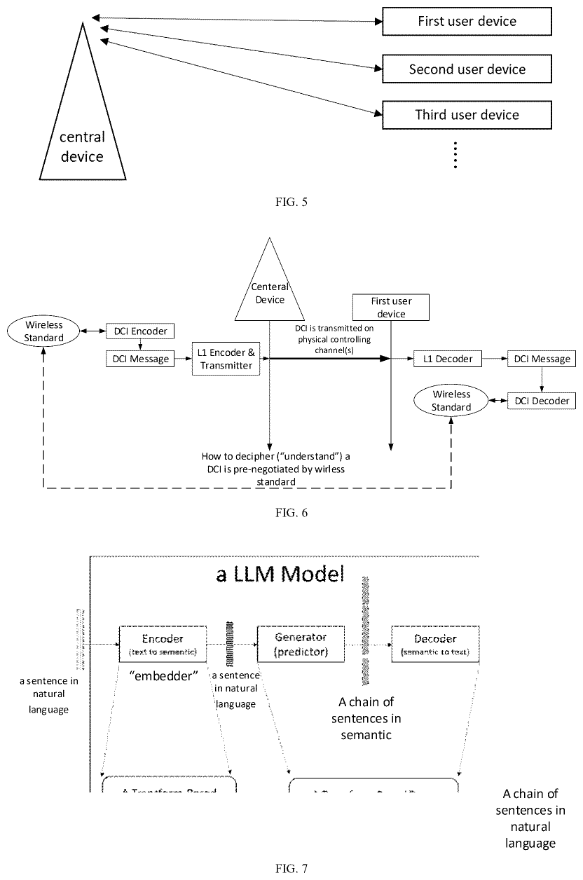

One or more steps of the embodiment methods provided herein may be performed by corresponding units or modules, according to FIG. 4. FIG. 4 is a block diagram of a device in a communication system according to one or more example embodiments of the present disclosure. FIG. 4 illustrates units or modules in a device or apparatus, such as in the ED 110, in the T-TRP 170, or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be a circuit such as an integrated circuit. Examples of an integrated circuit includes a programmed FPGA, a GPU, or an ASIC. For instance, one or more of the units or modules may be logical such as a logical function performed by a circuit, by a portion of an integrated circuit, or by software instructions executed by a processor. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170, and the NT-TRP 172 are known to those of skill in the art. As such, these details are omitted here.

In the past decades, industrial priority has been paid on bit communications by optimizing how to transmit more bits at lowest radio cost as a primary aspect of communication, i.e. transmission efficiency. In this aspect, channel coding and source coding theories have been well studied to guide how to design FEC (forward error correction) coding scheme, modulation scheme, and compression scheme, either lossy or lossless in the engineering domains. However, the priority on this aspect is overshadowing another aspect of communications, i.e. transmission effectiveness (sender triggers a desired conduct on the receiver).

In order for a receiver to conduct as a sender expects, receivers and senders should pre-negotiate some protocols between to map desired actions (observation or actuation) to bits. In modern wireless industry, these pre-negotiated protocols become a great portion of wireless standards that every equipment device follows. For example, in a wireless system, a new desired action mapped into several bits of a controlling message (or information in the message) cannot be used until the standardization is made and hardware equipment device compatible with the standardization is deployed.

The controlling messaging system (which is a system using pre-negotiated protocols for the controlling messages) in current communication system e.g., 4th generation (4G) and 5th generation (5G) system is a closed-vocabulary system available and accessible only to the transmission-related controlling messages, downlink control information (DCI) and uplink control information (UCI). A great portion of 5G wireless standard is dedicated to contents and formats of DCI and UCI. A pre-negotiated function (actions and arguments) at a receiver side is carefully mapped to some bits of a controlling message with some format. When a new transmission technology appeared (e.g., from 4G to 5G), some new and relevant controlling messages should be added into DCI and UCI or are defined as new DCI and UCI formats after years of standardization meetings and implementations. Similarly, when an old transmission technology got retired, the old controlling messages should be removed from DCI and UCI after years of meetings and implementations too. In the future that as the accelerating evolution of transmission technology requests faster updates in DCI and UCI, the current closed-vocabulary controlling messaging system would become an obstacle to any agile replacement.

Since 5G, Ultra Reliable Low Latency Communication (URLLC) has been discussed as one of the important application features for wireless systems. The recent AI technology has been speeding up driverless car and robotics and demanding more low-latency and high reliable communications. Unfortunately, these applications cannot enjoy the most reliable and fastest radio channels, because the controlling messages in these applications is not open to the radio technology (e.g., 5G) and can only be taken as data and will be transmitted only in data channel.

Every desired action is specifically defined and mapped on several bits of a controlling message. The definition and mapping should be well pre-negotiated and written into wireless standards and then be implemented on all the equipment users (UEs) and network node, e.g., base stations. A desired action includes a specific observation or actuation function modality. For example, a controlling message to request a receiver to conduct an action to measure the current “receiving signal power (e.g. reference signal received power(RSRP))” is a specific “observation” function modality (that doesn't change the state of the receiver); another controlling message to request a receiver to conduct an action to configure its “carrier frequency” is a specific “actuation” function modality (that alters the state of the receiver). It could be understood that, a communication protocol associates one controlling message to a function modality and another controlling message to another function modality. Controlling messages are cross modality.

A modern wireless cellular system like 5G contains a central device, e.g. (BTS, gNodeB, eNodeB), and at least one user device, e.g., (UE, user, terminal, IoT device and so on). In 5G, the central device is responsible for managing and maintaining the overall communication quality of all user devices associated to the central device, referring to FIG. 5 and FIG. 6. FIG. 5 is a schematic diagram of a communication system. FIG. 6 is a schematic diagram showing communications between a central device and a first user device.

The central device performs the management and maintaining jobs mostly through a controlling plane of the wireless system. The controlling plane includes a physical layer controlling channel (e.g., PDCCH for downlink and PUCCH for uplink) and a part of physical layer data channel (e.g., PDSCH for downlink and PUCCH for uplink), and a number of carefully standardized controlling messages. Usually, most controlling messages are robustly encoded (with lower coding rate and modulation scheme) without HARQ (for shorter latency purpose) and transmitted on the physical controlling channels. The content, format, and position & length of a standardized controlling message are well defined and specified so that all the equipment may exactly conform to. Usually, a standardized controlling message is short enough to form a small block to fit into DCI. Optionally, a standardized controlling message, if long enough, can be alternatively transmitted via physical data channels too.

Some bits of a standardized controlling message indicate a desired function modality, which is either observation (measurement) action and/or actuation (configuration or setup) action. Which bits are associated to which function modality is well specified (a kind of offline pre-negotiation) in the standard documents, to which both the central device and user device are aligned.

Some bits of a standardized controlling message indicate argument values for a function modality. Which bits and how many bits are associated to which arguments of a function modality is well specified (a kind of offline pre-negotiation) in the standard, to which both the central device and user device are aligned.

Adding a new function modality means updating some bits of a standardized controlling message, which takes years to be agreed in the standardization body and implemented by all the new equipment. For example, as the number of bits allocated for an argument value is fixed, the quantization of the value cannot be updated until the change to the number of bits is agreed by the standardization body and implemented by all the new equipment.

The central device generates a standardized controlling message by filling the bits exactly according to the pre-negotiated standard. Then the central device encodes the controlling message by some pre-negotiated coding and modulation scheme (MCS) and transmits it on a transmission opportunity within a physical radio allocation (controlling channel or data channel) to the user device.

The user device receives the controlling message from the transmission opportunity, decodes them according to the pre-negotiated MCS. The user device may conduct the function modality with the argument values in terms of the decoded bits from the controlling message.

Natural language is one of few carriers that not only support open-vocabulary and backward & forward compatibility but also accommodate cross-modality functionality. So far, all theory, rule, law, devices, knowledge, gadget, and even wireless standards are developed and stored in natural languages. Nevertheless, direct embedding a sentence in a natural language, for example by American Standard Code for Information Interchange (ASIC) letter-by-letter, is sensitive to order of words and formats of a sentence. For example, “Set the carrier frequency to 3.5 GHz” would be considered as different from “the carrier frequency should be set as 3.5 GHz”, even though both have the similar semantic meaning. Or “what is current received signal power?” and “Received signal power is high” makes a pair of a query and an answer close to the same semantic. During the past decades, no machine had been able to understand flexible and open sentence in natural languages or there had been no heuristic way to map and compare sentences in natural language in a common semantic domain.

Large-language-model (LLM) enables machine to “understand” sentences in natural languages. Although the primary goal of a LLM is to make extraction or predication (generation) in sentences, every LLM may contain some components that embeds a sentence in natural language into a semantic domain. Usually, these embedding components are realized by transformer-based deep neural network and trained with contrastive learning with a great amount of training samples. This paves a way for a machine to “understand” and “compare” different sentences in semantic domain.

There are at least one of several following issues in modern wireless system. Firstly, contents and formats of the controlling messages in wireless communication standards are pre-negotiated (standardized) to form a closed vocabulary in a transmission-only semantic context. The controlling messages are responsible for managing and maintaining an entire wireless communication system, given the most reliable and fastest physical channels. But this resource or capability is not open to other applications, especially ultra-reliable low-latency communication (URLLC) applications including driverless car or robotics, for example, a controlling message such as “emergency brake” for a driverless car can only be transmitted as data via physical data channel. Secondly, pre-negotiated (standardized) controlling messages in the wireless communication standards suffer from forward and backward compatibility. While some controlling messages that become “outdated” would still “occupy” some resource room in the physical channels, some new controlling messages (for new technology) couldn't be added until a new standard is released (e.g. years later). It has undermined the wireless system to benefit from cutting-edge transmission technology.

The current wireless system heavily relies on pre-negotiated (standardized) contents and formats of the controlling messages, mainly because a machine was unable to understand semantic meaning. For long, effectiveness communication had been considered as a propaganda theory, as human is only receiver who can catch semantic meaning of a sentence and conduct a desired action.

In the disclosure of the present invention, a method, apparatus and system for an open vocabulary controlling message in controlling message system in a natural language to support customer's function (non-wireless-related) is provided. In that way, some short-latency and reliable controlling messages will benefit from physical layers, especially the controlling plane.

Unlike a standardized DCI (i.e., in 4G and 5G), some controlling messages in a natural language that support conditionality and looping are introduced. In terms of computer programming theory, a program can be coded only with four types of instructions: read state, change state, condition, and looping. Strictly, looping instruction is not necessary but looping instruction can really help improve efficiency of a program.

A first possible advantage is efficiency. An open-vocabulary controlling message is associated to a function modality supported by a user device. This function modality is either observation (reading current state of the user device), or actuation (changing current state of the user device) or both. For example, to achieve a condition, a central device may fire at least two controlling messages: the first message for the observation (called as the observation message in this disclosure) and the second message for the actuation (called as the actuation message in this disclosure). In response to the observation message received from the central device, the user device may feedback at least once to report the current state. Now, with an open-vocabulary controlling message that supports condition, the two controlling messages can be combined in a conditional way to the user device. Just one fire from the central device is sufficient. For another example, to achieve a loop with open-vocabulary controlling messages, the central device has to keep sending a number of actuation controlling messages and one observation message and then again and again. But with an open-vocabulary controlling message that supports looping, the central device sends only one controlling message that indicates the loop.

A second possible advantage is to program a user device by a sequence of controlling messages in a natural language. In one implementation, DCI in 5G and closed-vocabulary controlling messages in are independent to each other, and there's no order among them. For example, DCIs transmitted in different time slots may be independent in 5G. Program is order-sensitive or order of program instructions matters (brings about critical (basic) information). When a controlling message supports condition and loop freely, the orders among a sequence of the controlling messages start to matter. The Programmable or configurable feature brings flexibility to the system design.

A third possible advantage is to enable the controlling message system to support conditional and looping controlling message in a natural language. It makes a controlling message be more efficient and concise. Moreover, with the support of the conditional and looping controlling message, the central device can program a user device by a sequence of controlling messages in a natural language. It is the true merit of a LLM model who can generate a chain of thoughts (=a sequence of sentences in a natural language).

In order to benefit more from the generative capability of a LLM model (which may become more and more powerful), the wireless system can allocate a particular resource in its physical layer for non-wireless controlling messages for customers, such as driverless car and robotics, who request a short-latency and reliable communication. Besides, in order to protect customer's privacy and commercial intellectual property, these function modalities at a user device and controlling messages to these function modalities are black box for the central device.

### Embedding Model of LLM

The central device schedules and manages user devices mostly through a controlling plane of the wireless system. The controlling plane includes a number of physical layer channels and a number of controlling messages. Unlike 5G, the disclosure of this invention comprises some open-vocabulary controlling messages in a natural language for backward and forward compatibility in wireless communication.

These controlling messages are called as open-vocabulary controlling messages in a natural language. The major reasons to employ a natural language rather than an artificial language (like 5G standardization) are as at least one of following:

Natural language is the best de-facto semantic “standard” for nearly everything. Wireless systems (e.g., 4G, 5G) have been discussed, developed, written, and standardized in a natural language (English).

Inference over a powerful LLM model can generate a chain or sequence of open-vocabulary controlling messages in natural language. If a modern wireless system took advantage of an ever-growing LLM model, it may be open for controlling messages in a natural language.

It is widely accepted to keep “man-in-the-loop” for LLM models in both training and inference periods. During a training period, “man-in-the-loop” can help regularize LLM model's behavior for safe and moral codes; during an inference period, “man-in-the-loop” can help retrace and accumulate real samples for human inspection. Both of the periods request a system to support controlling messages in a natural language.

In this disclosure, the central device is supposed to use a LLM to generate a chain of controlling messages in a natural language. How to build a LLM is open for individual implementation. A company, an operator, can gain its efficiency advantage by its LLM model. The company can keep improving its LLM models by “man-in-the-loop” reinforcement learning to update the LLM's generative models.

A typical LLM model may comprise several components: an encoder that translates, embeds, or tokenizes a sentence in a natural language into a semantic embedding, a generator or predictor that generates a sequence of semantic embeddings, and a decoder that translates generative semantic embeddings back to sentences or messages in a natural language. In some LLM models, a generator and a decoder are closely coupled together.

There is some randomness in a LLM model. For example, two semantic embeddings from the same input sentence in a natural language are not exactly same. But the two semantic embeddings are very relevant in the sense that their inner product is high.

There are many names for semantic embedding such as semantic vector, semantic token, token, and so on. In some LLM models, semantic embedding is in tensor; in other LLM models, semantic embedding is in matrix. Often, longer sentence in natural language would result into longer semantic embedding. In order to fit a semantic embedding into a wireless physical layer, an embedder is proposed:
Regularize a semantic embedding into a vector (semantic vector); for example, simply by vectorizing a tensor or matrix;
Pre-define a finite number of fixed lengths and then regularize the semantic vector into one of the fixed lengths. In general, longer sentence is regularized into a longer semantic vector;
Call the semantic vector of one of the pre-defined lengths as “semantic vector” in the following discussion;
Call the encoder component of a LLM and the regularizations above as “embedder”.

An embedding model is a component of a LLM model, referring to FIG. 7, which is a schematic diagram of a LLM model. In fact, it is the smallest, simplest, least energy-consuming one in a LLM model than generator and decoder that usually take billions of neurons.

In FIG. 7, a typical LLM model is illustrated. A sentence in a natural language is input into a LLM model. This sentence is firstly embedded into a semantic embedding by a deep neural network (for example, a transform-based deep neural network-1 in the figure). Then, the semantic embedding is input into a generator or predictor that will generate a chain of semantic embeddings following this input semantic embedding. The chain of semantic embeddings are translated to a chain of sentences in a natural language by a decoder. Optionally the generator and decoder may be combined together by a deep neural network (for example, another transform-based deep neural network-2 in the figure).

A function modality is an action conducted by a user device. An action includes observation and/or actuation. When a user device executes an observation action, the user device would measure some of its states or status. When a user device executes an actuation action, the user device would change some of its states or status. A function modality can be either observation action, or actuation observation, or both simultaneously.

FIG. 8 shows a schematic flowchart of a controlling method according to one or more example embodiments of the present disclosure. The method can be implemented by a first apparatus. Optionally, the first apparatus can be a central device or other device that has similar function (for example, the first apparatus could be a chip), which is not limited herein. As shown in FIG. 8, the method can include the following steps.

S810, generate a controlling message in natural language by using a language model (LM).

In the embodiment, the central device generates a controlling message in natural language by using a language model. In a possible implementation, the LM may be a language learning model (LLM).

In a possible implementation, the controlling message may indicate an action to be executed. The action to be executed may be an actuation action or an observation action.

In a possible implementation, the controlling message may further indicate information related to execution of the action indicated by the controlling message. In a possible implementation, the controlling message is a conditional controlling message or a looping controlling message. That is to say, the controlling message generated by the central device may be a conditional controlling message or a looping controlling message, which indicates an action to be executed and information related to execution of the action.

The conditional controlling message is a specific type of controlling message that includes conditionality, for example expressed through an “if, then” structure. It is used to specify actions that should be executed only if certain conditions are met. The looping controlling message is a type of controlling message that includes instructions for performing repeated actions, for example expressed through a looping structure, such as “while”, “do . . . while”, “do . . . until”, or “do . . . for”. It is used to indicate how many times an action should be executed or under what conditions an action should be repeated.

Since the controlling message generated by the central device can be a conditional controlling message or a looping controlling message, the controlling message in a natural language that support conditionality and looping is introduced in the system, which helps improve efficiency and flexibility of the communication system.

In a possible implementation, the information related to the execution of the action is based on a result of another action indicated by the controlling message. In other words, the information related to the execution of the action may depend on the outcome or output of another action indicated by the controlling message. In a possible implementation, the action may be an observation (measurement) action and/or actuation (configuration or setup) action, and another action indicated by the controlling message may be an observation (measurement) action. For example, the controlling message can be “If readState #2 is in a low range, then SetState #1(value #1).” In this case, the information related to the execution of the action “SetState #1(value #1)” is based on a result of the action “readState #2”.

Since the controlling message may include the information related to the execution of the action, which is based on a result of another action indicated by the controlling message, the action to be executed and the condition for the (repeated) execution of the action can be indicted by a single controlling message. Compared with a traditional process in which the user device needs to report an action result to the central device and then the central device instructs, based on the action result, the user device to execute the next action, a communication process for controlling can be simplified, and more complex and sophisticated control of wireless devices can be allowed.

By including a conditional controlling message or a looping controlling message, where the execution of an action is based on the result of another action, more complex and dynamic control scenarios can be allowed, where actions are performed based on the outcome of other actions, enabling better performance and energy efficiency of the communication system.

S820, obtain semantic information of the controlling message according to the controlling message.

In the embodiment, the central device obtains semantic information of the controlling message according to the controlling message. The semantic information also refers to the semantic vector, semantic embedding, semantic token, etc. in the present disclosure. The semantic information may be a numerical representation of the meaning or semantics of words, phrases, sentences, or documents.

In a possible implementation, the central device may determine a portion without any arguments from the controlling message, and obtain the semantic information of the controlling message by using an embedder and according to the portion.

The generated controlling message may include a list of arguments (values), and the central device may divide the controlling message into two portions: a first portion including the list of arguments if any and a second portion including the rest part of the controlling message, and the central device only translate the second portion into the semantic information. Since the arguments (values), which may vary, are not included in the second portion translated to the semantic information, the semantic information of the controlling message can be highly relevant to the semantic information of the corresponding function modality, thereby facilitating the central device to determine whether the controlling message is a registered one, and facilitating the user device to determine a corresponding function modality, and meanwhile, reducing the computational complexity and facilitating standardizing the length of the semantic information.

S830, form an information payload when the semantic information of the controlling message is relevant to one or more pieces of multiple pieces of semantic information, where the multiple pieces of semantic information correspond to multiple function modalities that have been registered to the LM, and a part or all of the multiple pieces of semantic information is obtained from at least one user device, and where the information payload includes the semantic information of the controlling message.

In the embodiment, a part or all of the multiple pieces of semantic information correspond to multiple function modalities that have been registered to the LM is obtained from at least one user device directly. In order to protect customer's privacy and commercial intellectual property, the central device may obtain the semantic information correspond to multiple function modalities rather than obtain the description of multiple function modalities. Therefore, these function modalities of at least one user device and controlling messages related to these function modalities are black boxes for the central device. In a possible implementation, a part of the multiple pieces of semantic information correspond to multiple function modalities that have been registered to the LM may be obtained by using an embedder based on descriptions of the multiple function modalities.

In a possible implementation, the multiple pieces of semantic information corresponding to the multiple function modalities that have been registered to the LM include multiple pieces of first semantic information each corresponding to a respective function modality in the multiple function modalities and obtained from a description of the respective function modality in the multiple function modalities. In a possible implementation, the multiple pieces of semantic information corresponding to the multiple function modalities further include at least one piece of second semantic information each obtained from a description relevant to a result of a function modality in the multiple function modalities. The multiple pieces of semantic information of multiple function modalities that have been registered may be stored in the central device, or a part of them may each be translated from a description of a function modality or a description relevant to a result of a function modality when using. Since the controlling message indicates an action to be executed and may further indicates information related to execution of the action, the multiple pieces of semantic information of multiple function modalities, which are used to compare with the semantic information of the controlling message, may include first semantic information obtained from a description of a function modality and may further include second semantic information obtained from a description relevant to a result of a function modality.

In a possible implementation, the central device may determine one or more pieces of semantic information most relevant to the semantic information of the controlling message from the multiple pieces of semantic information corresponding to the multiple function modalities that have been registered, and according to the relevance between the semantic information of the controlling message and each of the multiple pieces of semantic information corresponding to the multiple function modalities that have been registered; and may determine at least one user device ID or at least one group user device ID corresponding to the one or more pieces of most relevant semantic information; where the first information payload further includes: the at least one user device ID, or at least one group user device ID; or the first information payload further includes information indicative of the at least one user device ID or information indicative of the at least one group user device ID.

The central device may store a mapping relationship between each registered function modality and its corresponding information indicative of the at least one user device ID or information indicative of the at least one group user device ID. In a possible implementation, the central device may store a mapping relationship between each registered function modality and its user device ID or group user device ID. The central device may compute relevance between the semantic information of the controlling message and the semantic information of each function modality that has been registered, and then determine semantic information most relevant to the semantic information of the controlling message. When the most relevant semantic information is determined, the central device can retrieve the corresponding information indicative of the at least one user device ID or information indicative of the at least one group user device ID, or user device ID or group user device ID from its database or associated records. When the controlling message indicates an action to be executed and information related to execution of the action indicated the controlling message, the semantic information of the controlling message may be related to semantic information obtained from a description of a function modality and semantic information obtained from a description relevant to a result of a function modality.

In a possible implementation, the central device may reject the controlling message, when the relevance between the semantic information of the controlling message and each of the multiple pieces of semantic information is lower than a threshold.

The central device would determine a relevance between the semantic information of the controlling message and each of the multiple pieces of semantic information associated with the function modality that has been registered, to determine whether the controlling message is a registered one. When the relevance between the semantic information of the controlling message and the respective semantic information associated with each function modality registered is lower than a threshold, it can be determined that the controlling message is not registered, and the central device would reject the non-registered controlling message. The central device may not need to encode or transmit the non-registered controlling message and the central device may multicast or unicast the controlling message to only those user devices that have registered for the corresponding function modality, thereby saving the central device's and user device's power, and saving transmission resources.

In a possible implementation, the central device may form a first information payload, where the first information payload includes starting position information of a second transmission opportunity and length information of the semantic information of the controlling message, and the central device may form a second information payload, where the second information payload includes the semantic information of the controlling message, and where the second transmission opportunity is for transmission of the second information payload information.

The central device may form a first information payload and a second information payload to transmit the controlling message, which allows for more efficient use of radio resources and provides greater flexibility in terms of error correction and retransmission. Since the starting position information of the second transmission opportunity and the length information of the semantic information are included in the first information payload, the receiving device can synchronize and correctly receive the second information payload.

In a possible implementation, the controlling message further includes a list of arguments, and the first information payload further includes the list of arguments of the controlling message. If the controlling message further includes a list of arguments, the list of arguments would be included in the first information payload to transmit.

The central device allocates a trunk of radio resource for controlling messages. The first part of the radio resource is reversed for standardized controlling messages. The second part of the radio resource is allocated for open-vocabulary controlling messages that at least includes the first open-vocabulary controlling messages.

By reserving a trunk of radio resource for controlling messages and allocating separate parts for standardized and open-vocabulary messages, the central device can ensure that these messages are transmitted efficiently and without interference from other data transmissions.

In a possible implementation, the central device may encode the second information payload by using a first encoding method, where the first information payload further includes information of the first encoding method.

By including the first encoding method used to encode the second information payload in the first information payload, the user device can immediately identify the appropriate coding scheme required to decode the subsequent second information payload.

In a possible implementation, the method further includes: encoding the first information payload by using a second encoding method. The second encoding method and the first encoding method can be the same or different, which is not limited here.

In a possible implementation, the first encoding method includes a first modulation and coding scheme (MCS), and the second encoding method includes a second MCS. The first and the second encoding method may be MCS. In a possible implementation, the first encoding method and the second encoding method may be other encoding methods that can be used for wireless transmission, such as pulse amplitude modulation (PAM), frequency shift keying (FSK), phase shift keying (PSK), quadrature amplitude modulation (QAM), and so on.

S840, send the information payload.

In a possible implementation, the central device may send the first information payload during a first transmission opportunity; and send the second information payload during the second transmission opportunity.

The central device may send the first information payload and the second information payload during the first transmission opportunity and the second transmission opportunity respectively. Thus the central device can allocate the radio resource more effectively by assigning different transmission opportunities to each payload, and can help prevent congestion and ensure that the information is transmitted smoothly.

In a possible implementation of the first aspect, the information payload is sent via a multicast message or a unicast message.

A central device generates a controlling message in natural language, and when the semantic information of the controlling message is relevant to one or more pieces of multiple pieces of semantic information, the central device forms an information payload including semantic information of the controlling message to control a user device, where a part or all of the multiple pieces of semantic information is obtained from at least one user device. In this way, an open vocabulary can be supported in controlling, more effective and flexible communication can be achieved, backward and forward compatibility can be supported, cross-modality functionality can be accommodated, and customer's privacy and commercial intellectual property can also be protected.

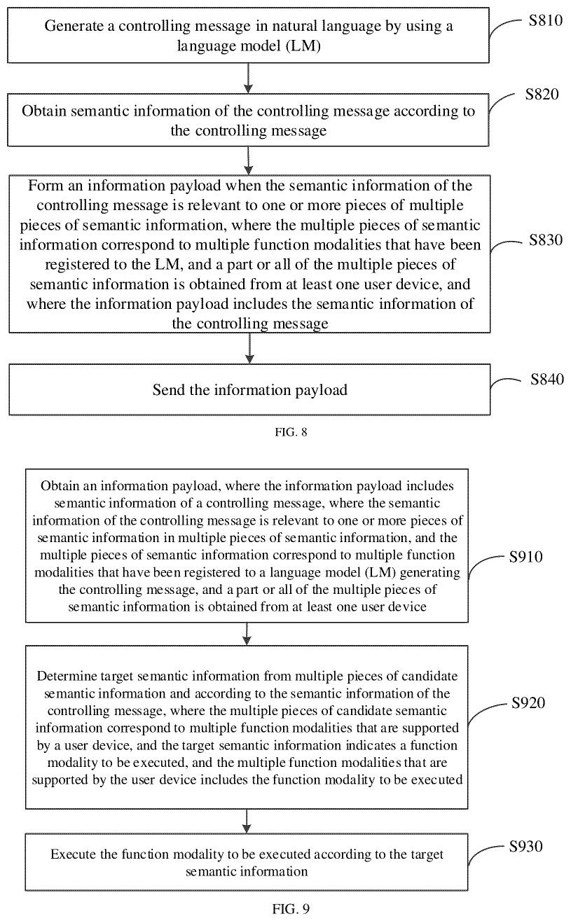

FIG. 9 shows a schematic flowchart of a controlling method according to one or more example embodiments of the present disclosure. The method can be implemented by a second apparatus. Optionally, the second apparatus can be a user device or other device that has similar function (for example, the second apparatus could be a chip), which is not limited herein. As shown in FIG. 9, the method can include the following steps.

S910, obtain an information payload, where the information payload includes semantic information of a controlling message, where the semantic information of the controlling message is relevant to one or more pieces of semantic information in multiple pieces of semantic information, and the multiple pieces of semantic information correspond to multiple function modalities that have been registered to a language model (LM) generating the controlling message, and a part or all of the multiple pieces of semantic information is obtained from at least one user device.

In the embodiment, the user device obtains an information payload, and the information payload includes semantic information of the controlling message. The semantic information of the controlling message is relevant to one or more pieces of semantic information in multiple pieces of semantic information, and the multiple pieces of semantic information correspond to multiple function modalities that have been registered to an LM generating the controlling message. The controlling message is in natural language, and is generated by a central device to instruct a receiver to conduct a specific action. The semantic information of the controlling message may be a numerical representation of meaning or semantics of the controlling message. In a possible implementation, the LM may be an LLM.

In a possible implementation, the controlling message may be a conditional controlling message or a looping controlling message. Since the controlling message generated by the central device can be a conditional controlling message or a looping controlling message, the controlling message in a natural language that supports conditionality and looping is introduced in the system, which helps improve efficiency and flexibility of the communication system.

In a possible implementation, the information related to the execution of the function modality is based on a result of another function modality as indicated by the controlling message. Since the controlling message may include the information related to the execution of the action, which is based on a result of another action indicated by the controlling message, the controlling message can indicate the action to be executed and a basis or condition for the execution of the action to a user device through a single controlling message. Compared with a traditional process in which the user device needs to report an action result to the central device and then the central device instructs, based on the action result, the user device to execute the next action, a communication process for controlling can be simplified, and more complex and sophisticated control of wireless devices can be allowed.

In a possible implementation, after obtaining the at least one information payload, the user device may decode the at least one information payload. The user device can obtain the semantic information of the controlling message and other information by decoding the information payload.

In a possible implementation, the information payload may include: a first information payload, obtained during a first transmission opportunity, and including starting position information of a second transmission opportunity and length information of the semantic information of the controlling message; and a second information payload, obtained during the second transmission opportunity, and including the semantic information of the controlling message.

In a possible implementation, the user device may decode the first information payload to obtain the starting position information of the second transmission opportunity and the length information of the semantic information of the controlling message; and decode the second information payload to obtain the semantic information of the controlling message.

The user device may obtain the first information payload during the first transmission opportunity, and decode the first information payload to obtain the starting position information of the second transmission opportunity and the length information of the semantic information of the controlling message. The user device may obtain the second information payload during the second transmission opportunity according to the starting position information of the second transmission opportunity and the length information of the semantic information of the controlling message, where the second information payload includes the semantic information of the controlling message. After obtaining the second information payload, the user device may decode the second information payload to obtain the semantic information of the controlling message.

The user device may obtain the first information payload and the second information payload during the first transmission opportunity and the second transmission opportunity respectively. Thus the radio resource can be allocated more effectively by assigning different transmission opportunities to each payload, and the process of obtaining and decoding the information payload ensures the reliable retrieval of the semantic information of the controlling message.

The first transmission opportunity and the second transmission opportunity do not indicate order in which the first information payload and the second payload reach to the user device. In other words, from radio resource view, it is not mandatory that the transmission opportunity may reach to the first user device before the second opportunity. The first information payload and the second information payload may be encoded and transmitted during different transmission opportunities, which allows for more efficient use of radio resources and provides greater flexibility in terms of error correction and retransmission.

The first information payload includes starting position information of the second transmission opportunity and length information of the semantic information of the controlling message. Thus the receiving device can synchronize and correctly receive the second information payload according to the first information payload.

In a possible implementation, the first information payload may further include: a list of arguments of the controlling message.

In a possible implementation, the first information payload may further include information of a first encoding method, and the second information payload is decoded by using the first encoding method. By including the first encoding method used to encode the second information payload in the first information payload, the user device can immediately identify the appropriate coding scheme required to decode the subsequent second information payload.

In a possible implementation, the first information payload may be decoded by using a second encoding method.

In a possible implementation, the first encoding method may include a first modulation and coding scheme (MCS), and the second encoding method include a second MCS.

In a possible implementation, the first encoding method and the second encoding method may be other encoding methods that can be used for wireless transmission, such as pulse amplitude modulation (PAM), frequency shift keying (FSK), phase shift keying (PSK), quadrature amplitude modulation (QAM), and so on.

In a possible implementation, the first information payload may further include: information indicative of a user device ID or information indicative of a group user device ID. Since the information indicative of the user device ID or information indicative of the group user device ID is included in the first information payload, the user device can determine whether it is a correct recipient according to the first information payload, thereby improving the efficiency and accuracy of the communication system.

In a possible implementation, in response to determining that the user device ID or the group user device ID does not match a user device ID or a group user device ID of the user device, the user device may refrain from decoding the second information payload. When the user device identifier is indicated in the first information payload, the user device may refrain from decoding the second information payload in a case that the user device finds that the decoded user device ID or the decoded group user device ID doesn't match that of itself, thereby saving the energy and processing resources of the user device. Since the information indicative of the user device ID or information indicative of the group user device ID is included in the first information payload, the user device can determine whether it is a correct recipient according to the first information payload, thereby improving the efficiency and accuracy of the communication system.

S920, determine target semantic information from multiple pieces of candidate semantic information and according to the semantic information of the controlling message, where the multiple pieces of candidate semantic information correspond to multiple function modalities that are supported by a user device, and the target semantic information indicates a function modality to be executed, and the multiple function modalities that are supported by the user device includes the function modality to be executed.

In the embodiment, the user device determines target semantic information by comparing the semantic information of the controlling message obtained from the central device and all its candidate semantic information. Each piece of candidate semantic information corresponds to a function modality in multiple function modalities supported by the user device. Each piece of candidate semantic information may be obtained according to a description of a corresponding function modality or a description relevant to a result of a corresponding function modality. The description of a function modality is used to describe the function modality. Both the description of the corresponding function modality and the description relevant to the result of the corresponding function modality are in natural language. The candidate semantic information may be stored in the user device, or may be obtained every time the user device needs.

In a possible implementation, the user device may determine at least one piece of candidate semantic information most relevant to the semantic information of the controlling message as the target semantic information from the multiple pieces of candidate semantic information. The user device may compute the relevance or similarity between the semantic information obtained from the central device and all its candidate semantics. Based on the relevance computation, the target semantic information is identified as the most relevant to the semantic information.

In a possible implementation, the target semantic information further indicates information related to execution of the function modality.

S930, execute the function modality to be executed according to the target semantic information.

In the embodiment, after determining the target semantic information, the user device executes the function modality corresponding to the target semantic information.

A user device may obtain an information payload, where the information payload includes semantic information of a controlling message, where the semantic information of the controlling message is relevant to one or more pieces of semantic information in multiple pieces of semantic information, and the multiple pieces of semantic information correspond to multiple function modalities that have been registered to a language model (LM) generating the controlling message, and a part or all of the multiple pieces of semantic information is obtained from at least one user device; and determine target semantic information from multiple pieces of candidate semantic information and according to the semantic information of the controlling message, where the multiple pieces of candidate semantic information correspond to multiple function modalities that are supported by a user device, and the target semantic information indicates a function modality to be executed, and the multiple function modalities that are supported by the user device includes the function modality to be executed; and may execute the function modality to be executed according to the target semantic information. In this way, an open vocabulary can be supported in controlling, more effective and flexible communication can be achieved, backward and forward compatibility can be supported, cross-modality functionality can be accommodated, and customer's privacy and commercial intellectual property can also be protected.

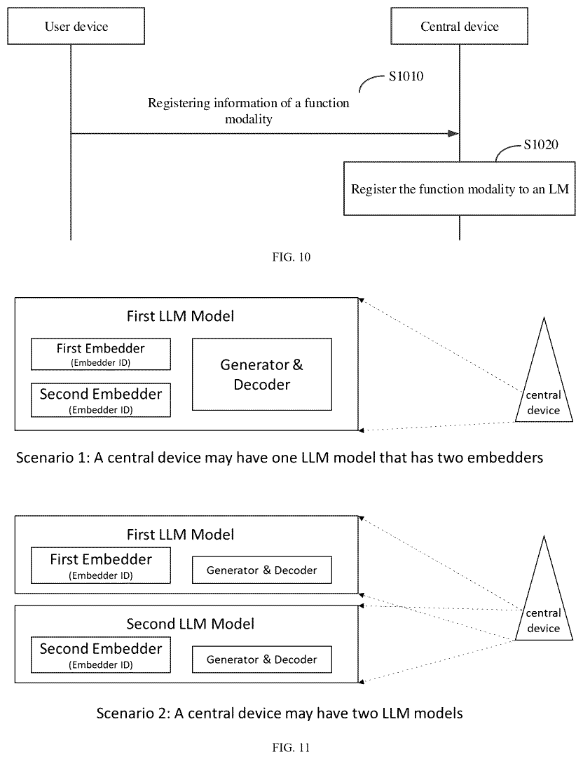

FIG. 10 shows a schematic flowchart of a registering process according to one or more embodiments of the present disclosure. As shown in FIG. 10, the method can include the following steps.

S1010, a user device sends multiple pieces of registering information of multiple function modalities, where each of at least one piece of registering information includes one or more pieces of semantic information of a corresponding function modality, where the multiple pieces of registering information include the at least one piece of registering information.

In the embodiment, the user device sends multiple pieces of registering information of multiple function modalities to the central device. The registering information of respective function modalities may be sent separately, or together, for example in an information packet, or the registering information of part of the function modalities may sent together, which is not limited in the present disclosure. Each piece of registering information included in the multiple pieces of registering information includes one or more pieces of semantic information of a corresponding function modality. In a possible implementation, the registering information of one or more function modalities may further include a list of arguments of the respective function modalities.

A user device in real-world comprises a number of states and a number of observation functions and actuation functions, a function modality comprises at least an observation function to read at least one state or at least an actuation function to change at least one state.

A function modality is an action conducted by a user device. An action includes observation and/or actuation. When a user device executes an observation action, the user device would measure some of its states or status. When a user device executes an actuation action, the user device would change some of its states or status. A function modality can be either observation action, or actuation observation, or both simultaneously.

In a possible implementation, the user device may encapsulate each of the multiple function modalities that are supported by the user device in a calling function to obtain multiple calling functions, where each of the multiple calling functions includes a description of a respective function modality, where the description is in natural language. The calling function is used to interact with a corresponding function by sending requests and processing the data returned by the corresponding function.

In a possible implementation, each of one or more calling functions in the multiple calling functions further includes at least one of: a list of arguments of the respective function modality or at least one description relevant to a result of the respective function modality, where the at least one description relevant to the result of the function modality is in natural language, and includes a conditional description describing a condition on the result of the respective function modality, or a looping description describing a loop with a condition on the result of the respective function modality.

In a possible implementation, the calling function may include an application programming interface (API) calling function. The API is a set of rules, protocols, and tools that allows different software applications to communicate and interact with each other. The API defines methods and data formats that applications can use to exchange information and request services from each other.

Each function modality may have a respective API corresponding to its description. And when a function modality further has a description relevant to the result of the function modality, which may be a conditional description or a loop description, there will be an API corresponds to the description relevant to the result of the function modality, which may be a conditional API or a looping API.

Since the calling function, such as the API calling function, can be implemented in various programming languages, by encapsulating each function modality of the at least one function modality into a calling function, it becomes easier to integrate and use within different programming languages, and promote interoperability between different systems or components that may be developed using different technologies.

In a possible implementation, the user device may use other technologies to achieve the functionality of interacting with a function modality. For example, the user device could directly call the function modality using an appropriate programming language's syntax, and this approach may be suitable for smaller applications or when the function modality is tightly coupled with the rest of the application's logic. For another example, if the function modality is provided as a library or software development kit (SDK), the system can directly integrate and use the library functions within an application code. For still another example, in a distributed system, the function modality may be implemented as a standalone service accessible through a network. The system can interact with the function modality using standard communication protocols such as representational state transfer (REST), gRPC, or message queues.

In a possible implementation, the one or more pieces semantic information of the corresponding function modality include a piece of semantic information obtained from a description of the corresponding function modality, where the description of the corresponding function modality is in natural language.

Since the registering information of a function modality includes a piece of semantic information associated with a function modality rather than the description corresponding to the function modality, the system can accommodate the cross-modality functionality and support backward and forward compatibility, rather than transmitting the description of the function modality to the central device, the function modality is black box for the central device, thereby protecting customer's privacy and commercial intellectual property.

In a possible implementation, the one or more pieces of semantic information of the corresponding function modality may further include at least one piece of semantic information relevant to a result of the corresponding function modality, where the at least one piece of semantic information relevant to the result of the corresponding function modality is obtained from at least one description relevant to the result of the corresponding function modality, and the at least one description relevant to the result of the function modality is in natural language. Since the one or more pieces of semantic information of the function modality may further include at least one piece of semantic information relevant to a result of the function modality, more complex and sophisticated control of wireless devices can be supported.

In a possible implementation, each of one or more pieces of registering information includes a list of arguments of a corresponding function modality, where the multiple pieces of registering information include the one or more pieces of registering information.

Since the registering information of a function modality may include semantic information of the function modality or further include semantic information relevant to a result of the function modality and/or a list of arguments of the function modality, the system can accommodate the cross-modality functionality and support backward and forward compatibility, and when new function modalities are added, they can be registered with the semantic information associated with the new function modalities without requiring changes to the system architecture or communication protocols, which improves the universality of the system, and makes the system more flexible.

In a possible implementation, correspondingly, the central device may obtain registering information of a function modality, where the registering information includes one or more pieces of semantic information of the function modality, and the function modality belongs to the multiple function modalities.

In a possible implementation, the central device may send configuration information of at least one embedder. The LM may register its embedder into the system, which may include the central device and the user device. The central device may send configuration information of the embedder to the user device, to register the embedder to the user device. When there is an embedder introduced or updated, the central device may send the configuration information, including, such as architecture and parameters (neuron values) of the embedder to the user device. In a possible implementation, the configuration information of the at least one embedder is sent via a broadcast message, a multicast message, or a unicast message. In a possible implementation, the LM may be a language learning model (LLM).

Correspondingly, the user device may obtain configuration information of at least one embedder. The user device may register or update the at least one embedder after obtaining the configuration information.

In a possible implementation, the user device may obtain the configuration information of at least one embedder. Through the configuration information of at least one embedder, the at least one embedder can be configured to the user device and then the user device can use the at least one embedder to translate the description of the function modality to semantic information.

In a possible implementation, multiple embedders (e.g. including a first embedder and a second embedder) may be registered in the system. The multiple embedders may be included in the same LM or in different LMs.

For example, when there is a second embedder and the second embedder is introduced or updated, the central device may transmit the configuration of the second embedder to all the user devices. In some cases, the first LM model may have the first embedder and the second embedder; in other cases, the first LM model has the first embedder and a second LM model has the second embedder.

In a possible implementation, the configuration information of the at least one embedder may be sent via a broadcast message, a multicast message, or a unicast message.

There may be one or more LMs, and each LM may include one or more embedders, the function modality may be registered to at least one of the one or more LMs. Different LMs or embedders may be compatible with different types of communication systems or used for different application scenarios. By allowing for multiple LMs to be deployed on the central device, the system becomes more flexible and customizable. When different embedders are built on different domains, specialization on the vocabulary can greatly reduce the size and cost of the embedder but also improve the accuracy of the relevance computation.

In a possible implementation, the configuration information of the at least one embedder includes an architecture and parameters of each of the at least one embedder.

In a possible implementation, the configuration information of the at least one embedder further includes an embedder ID of each of the at least one embedder. In a possible implementation of the second aspect, the configuration information of the at least one embedder further includes an embedder ID of each of the at least one embedder.

The configuration information of the embedder may include an architecture and parameters of each embedder, and the configuration information of the embedder may further include an embedder ID of each embedder, which facilitates the configuration of each embedder to the user device. Through the configuration information of at least one embedder, the at least one embedder can be configured to the user device and then the user device can use the at least one embedder to translate the description of the function modality to semantic information.

In a possible implementation, the user device may obtain by using the at least one embedder, one or more pieces of semantic information for each function modality of the multiple function modalities that are supported by the user device, and store the one or more pieces of semantic information.

The user device may use each of the at least one embedder to obtain one or more pieces of semantic information for each of the at least one function modality, and may store the obtained semantic information, which enables the user device to access and utilize the semantic information when needed quickly.

In a possible implementation, the one or more pieces of semantic information for each function modality may include a piece of semantic information obtained from a description of each function modality. The description of each function modality is in natural language.

In a possible implementation, the one or more pieces of semantic information for each of one or more function modalities may further include at least one piece of semantic information obtained from at least one description relevant to a result of a corresponding function modality, where the multiple function modalities includes the one or more function modalities.

In a possible implementation, the first information payload may further include information indicative of the embedder ID of a first embedder, and the user device may obtain the multiple pieces of candidate semantic information from the stored one or more pieces of semantic information and according to the information indicative of the embedder ID of the first embedder. There may be one or more embedders registered in the system. The target semantic information may be determined from the candidate semantic information which is obtained by the same embedder as the embedder used to obtain the semantic information included in the information payload. For example, the central device can inform the user device of an embedder ID of the first embedder which is used to obtain the semantic information included in the information payload. Since the user device may compare the semantic information of the controlling message with the candidate semantic information obtained by using the same embedder, accuracy and reliability of the comparing result would be improved.

S1020, the central device records the registering information of the function modality.

In the embodiment, after obtaining the registering information, the central device stored the registering information locally for further use, thereby facilitating further maintenance.

In a possible implementation, the central device may record information indicative of a user device identifier (ID) or a group user device ID of a user device from which the registering information of the function modality is received. The central device may associate information indicative of a user device ID of a user device or a group user device ID of a user device group, from which the registering information of the function modality is received, with the corresponding function modality, and may record the association relationship. That is to say, the central device may record a user device ID of a user device or a group user device ID of a user device group along with the semantic information and the list of arguments (if any) of the function modality that the user device or the user device group has. The central device may record a user device ID of a user device or a group user device ID of a user device group together with the registering information for further use, to call respective function modalities of different user devices more directly without the need for additional communication or negotiation, thereby helping optimize the utilization of transmission resources.

An example scenario of the controlling method of the present disclosure will be described in the following description for ease of understanding. It should be noted that the example scenario is for illustration purpose only, which should not be construed as limitations to the solution of the present disclosure.

In FIG. 7, a typical LLM model is illustrated. A sentence in a natural language is input into a LLM model. This sentence is firstly embedded into a semantic embedding by a deep neural network (for example, a transform-based deep neural network-1 in the figure). Then, the semantic embedding is input into a generator or predictor that will generate a chain of semantic embeddings following this input semantic embedding. The chain of semantic embeddings is translated to a chain of sentences in a natural language by a decoder. Optionally the generator and decoder may be combined together by a deep neural network (for example, another transform-based deep neural network-2 in the figure).

As illustrated in scenario 1 of the following FIG. 11, a first LLM model may register its first embedder into the system, in which a central device and at least a first user device will register the first embedder. When the first embedder is introduced or updated, the central device configures the first embedder, including the architecture and the parameters (neuron values), to all the user devices in a broadcast, multicast, or even unicast way.

When there is a second embedder and the second embedder is introduced or updated, the central device may transmit the second embedder to all the user devices. In some cases, the first LLM model may have the first embedder and the second embedder; in other cases, the first LLM model has the first embedder and a second LLM model has the second embedder. For example, the first embedder is English and the second embedder is Chinese, or, the first embedder is a general one and the second embedder is limited to IoT (much smaller and faster).

As LLMs are open for individual implementation, a central device may have more than one LLM model as illustrated in scenario 2 of FIG. 11. For example, the first LLM model is built by a company-A for green-energy equipment management; the second LLM model is built by a company-B for smart-city traffic sensors. The details for each LLM model could refer to above description.

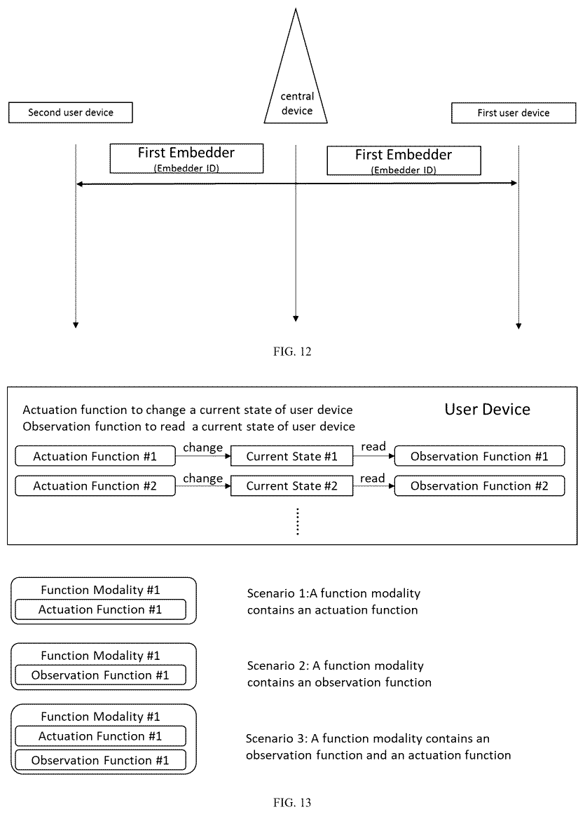

The central device may inform all the user devices of the embedder identifier, if there are more than one embedder, when configuring an embedder, see the following FIG. 12.

### Registering Function Modality Into System

A function modality is an action conducted by a user device. An action includes observation and/or actuation. When a user device executes an observation action, the user device would measure some of its states or status. When a user device executes an actuation action, the user device would change some of its states or status. A function modality can be either observation action, or actuation observation, or both simultaneously. In FIG. 13, an example of two states, state #1 and state #2 is given. To access the states (state #1 and state #2), a function is needed. Suppose that a function can access to only one state. This function can be either to change the state (actuation function, for example, an actuation function can be: “SetState #1(value)”) or to read the state (observation function, for example, an observation function can be: “Result =ReadState #1(void)”, “IsState #1HigherThan(value)”, or “IsState #1InRangeBetween(value1, value2)”), or read and change the state (actuation & observation function) simultaneously.

At least a first function modality is enabled, equipped, or implemented on at least a first user device. In order for the central device to make use of the first function modality enabled on the first user device, the system registers the first function modality into the system if the first function modality is new or updated to the system.

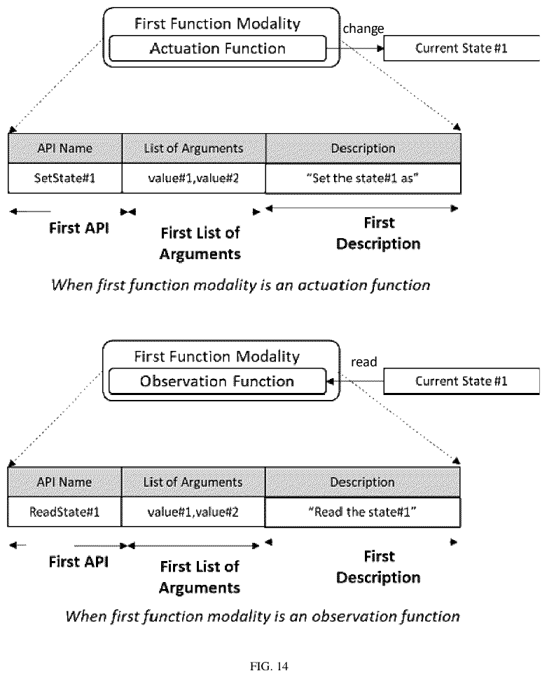

On the first user device, the first function modality may be encapsulated into at least a first API (application programming interface) calling function, see FIG. 14. The first API calling function may be in various programming languages such as C, Java, Python, C++, assemble etc. The first API calling function may have a first list of arguments. The first API calling function may have a first description that describes the first function modality in a natural language. Please note that a function modality may be achieved by a sequence of API functions, though one function modality by one API function is preferred. A function modality shown in FIG. 14 comprises API, list of arguments, and description in a natural language.

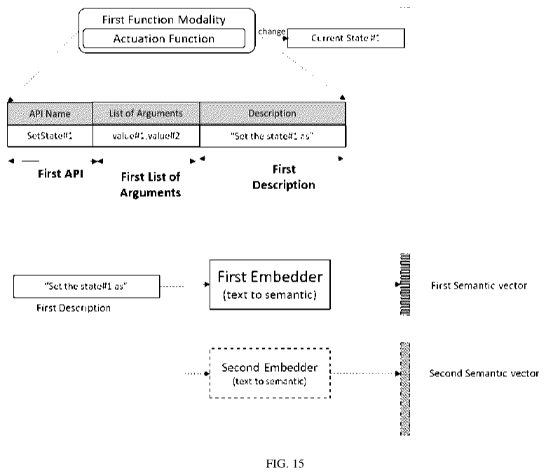

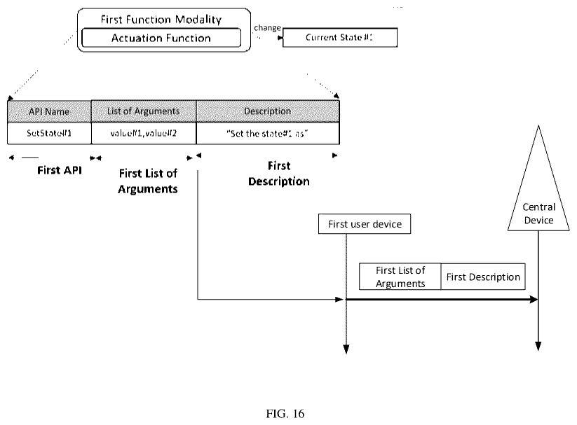

Optionally, as illustrated in FIG. 15, the first user device may use the first embedder to translate the first description into a first semantic vector (or a batch of first semantic vectors with different lengths) and then store it. Or the first user device may use the second embedder to translate the first description into a second semantic vector (or a batch of second semantic vectors with different lengths) and then store it. Or the first user device may use the first embedder to translate the first description into a first semantic vector each time that it needs instead of storing it. Due to some randomness in the first embedder, the first semantic vectors generated by the first embedder may not be exactly the same but very close on the semantic domain.

As illustrated in FIG. 16, the first user device may inform the central device of the first function modality by transmitting the first description and the first list of arguments to the central device. The first user device transmits the first description of the first function modality to the central device in order that the central device registers the first function modality into the system.

After receiving the first description and the first list of arguments, the central device may register the first function modality into the first LLM model by providing the first description and the first list of arguments. Optionally, the central device may register the first function modality into the second LLM model by providing the first description and the first list of arguments, if there is the second LLM model.

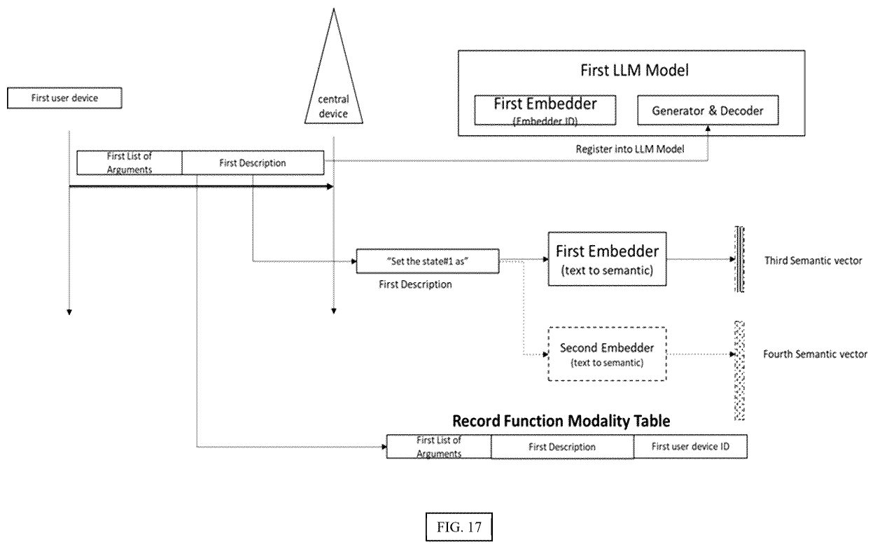

Optionally, as shown in FIG. 17, the central device may use the first embedder to translate the first description into a third semantic vector (or a third batch of semantic vectors with different lengths), and then store it. Preferably, the central device may associate the first user device identifier to the first function modality. Or the central device may use the second embedder to translate the first description into a fourth semantic vector (or a fourth batch of semantic vectors with different lengths) and then store it, if there is the second embedder. Or the central device may use the first embedder to translate the first description into a third semantic vector each time that it needs instead of storing it. Due to some randomness in the first embedder, the third semantic vectors generated by the first embedder may not be exactly the same but very close on the semantic domain.

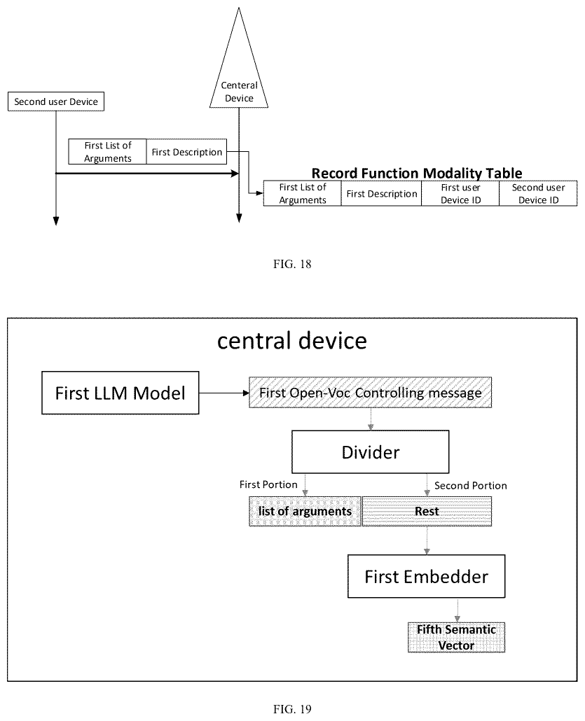

As illustrated in FIG. 18, if a second user device has the same first function modality, the second user device may provide the first description and the first list of arguments to the central device. The central device may add the second user device identifier with the first function modality. That is to say, if the first function modality has been registered, the central device may record the second user device that supports the first function modality.

If a second user device has a second function modality (new or updated), the second user device may provide a second description and a second list of arguments to the central device. The central device may record the second user device identifier with the second function modality. In turn, the central device may inform the first LLM model provider of the second function modality by providing the second description and a second list of arguments to the first LLM model provider. Optionally, the central device may inform the second LLM model provider of the second function modality by providing the second description and a second list of arguments to the second LLM model provider, if there are more than one LLM model provider.

Although the first user device and central device use the same first embedder to translate the same first description, the first semantic vector and the third semantic vector may not be exactly the same due to some randomness of the first embedder. However, the first semantic vector and the third semantic vector have a strong semantic relevance.

If the central device generates at least two consecutive open-vocabulary controlling messages for a user device all the time, it means that the two function modalities can be combined into one function modality. The central device and the user device may negotiate to generate a third function modality that has a third function API. The third API function calls the two function API successively. Along with the running time, new function modality that encapsulates a plurality of old function modalities in some order would be created so that the effectiveness gets improved.

As illustrated in FIG. 19, the central device uses the first LLM model to generate at least a first open-vocabulary controlling message. The first controlling message in natural language may include a list of arguments (values) and is targeted at the first function modality on the first user device.

The central device divides the first open-vocabulary (Open-Voc) controlling message into two portions: the first portion comprising the list of arguments if any and the second portion comprising the rest part of the first open-vocabulary controlling message.

The central device may choose a first length and use the first embedder to translate the second portion of the first open-vocabulary controlling message into a fifth semantic vector.

The central device may use the first embedder to translate description of the first function modality into a third semantic vector.

Although the fifth semantic vector and the third semantic vector may not be exactly the same due to some randomness of the first embedding model, the fifth semantic vector and the third semantic vector indicate a strong semantical relevance.

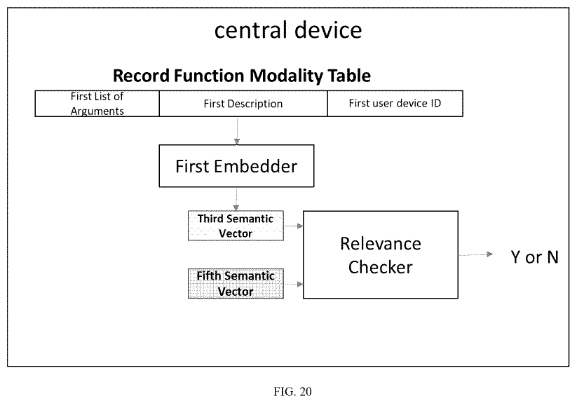

Optionally, as shown in FIG. 20, the central device may compare the relevance between the fifth semantic vector and the third semantic vector to a first threshold. If the relevance between the fifth semantic vector and the semantic vector of each registered function modality is lower than the first threshold, the central device may judge that the first controlling message is non-registered one; otherwise, the central device may judge that the first controlling message is registered one. The central device may dismiss a non-registered one.

One of the advantages is that the central device may multicast or unicast to the user devices whom are registered with the relevant function modality, thereby saving the user device's power.

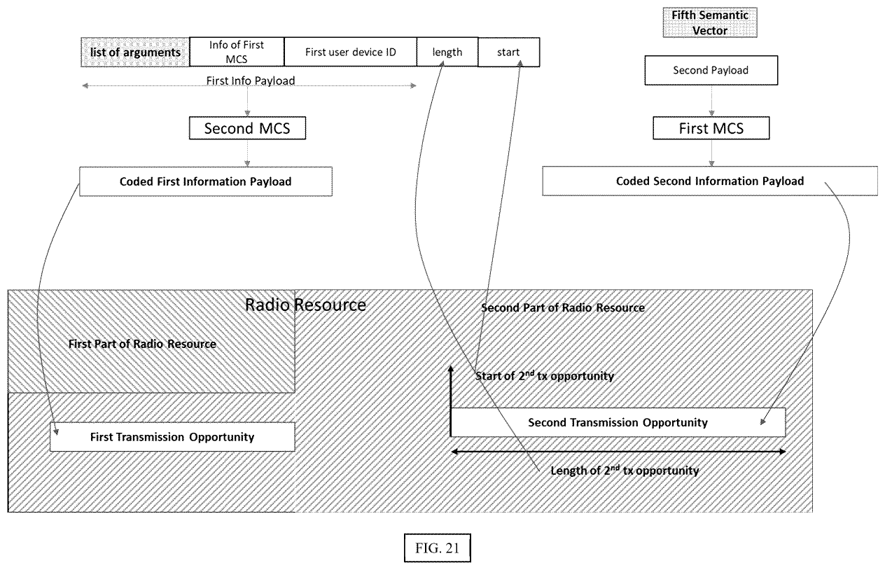

As shown in FIG. 21, the central device may encode and transmit the list of arguments of the first open-vocabulary controlling message during a first transmission opportunity, and encode and transmit the fifth semantic vector during a second transmission opportunity.

That is to say, the central device may encode and transmit an open-voc controlling message in two transmission opportunity.

The central device allocates a trunk of radio resource for controlling messages. The first part of the radio resource is reversed for standardized controlling messages. The second part of the radio resource is allocated for open-vocabulary controlling messages that at least includes the first open-vocabulary controlling messages.

The central device may form a first information payload that comprises the list of arguments of the first open-vocabulary controlling message, a starting position of the second transmission opportunity, the first length of the fifth semantic vector, a first MCS that encodes the fifth semantic vector, optionally the first user device identifier. The central device uses a second MCS to encode the first information payload. The central device grants the first transmission opportunity in the second part of the radio resource to transmit the first information payload.

The central device may form the second information payload that comprises the fifth semantic vector. The central device uses the first MCS to encode the second information payload. The central device grants the second transmission opportunity with the starting position and the first length in the second part of the radio resource to transmit the second information payload.

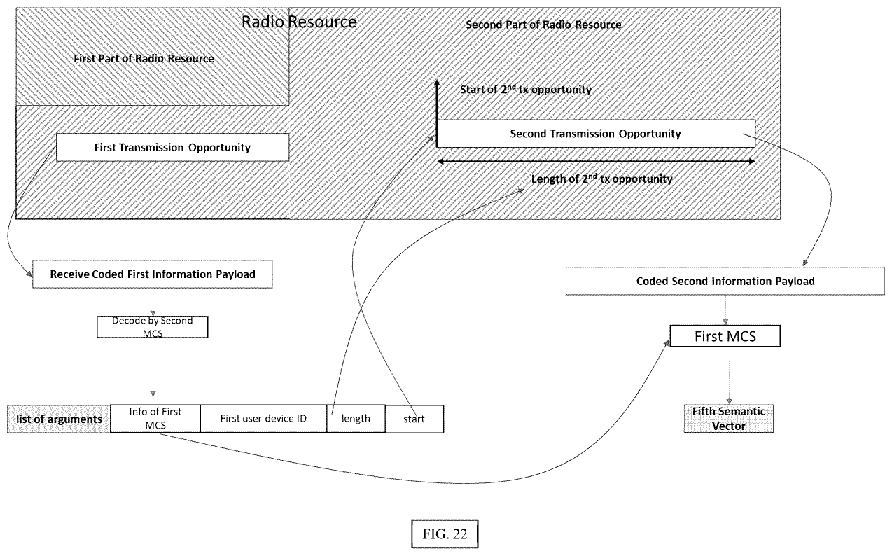

As illustrated in FIG. 22 the first user device receives the first transmission opportunity (i.e., receives some information on the first transmission opportunity). The first user device uses the second MCS to decode the first information payload. Optionally if the user device identifier is transmitted in the first information payload, the first user device may stop decoding the second information payload, if the first user device finds that the decoded user device identifier doesn't match.

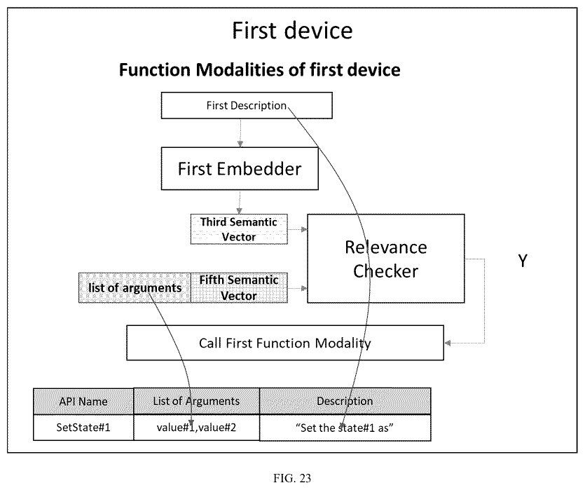

As illustrated in FIG. 23, the first user device decodes the list of the arguments of the first open-vocabulary controlling message, the starting position of the second transmission opportunity, the first length of the fifth semantic vector, the first MCS. With them, the first user device receives the second transmission opportunity and decodes the fifth semantic vector by the first MCS.

The first user device computes the relevance between the fifth semantic and all its candidate semantic that includes at least the first semantic vector. The first user device may select the first semantic as the most relevant to the fifth semantic. Then, the first user device may call the first API calling function with the arguments that the first user device decodes in the first transmission opportunity. Finally, the first user device executes the first function modality with the right arguments.

From the top level, the central device transmits the first controlling message in a natural language to the first user device who executes the first function modality.

In addition to above examples, the following are some further description for this disclosure.

### Registering a Conditional Function Modality

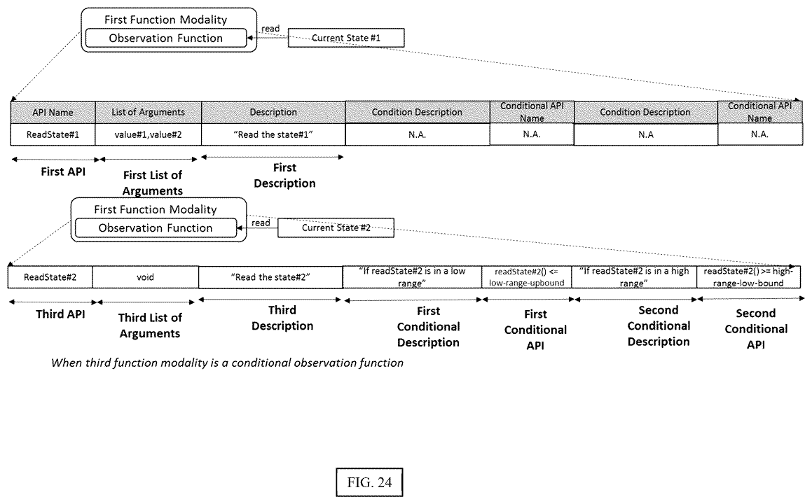

As illustrated in FIG. 24, the first user device may have a third function modality. The first function modality is associated to an actuation action, that is, to set the state #1 of the first user device as “value #1”. The third function modality is associated to an observation action, that is, to read the state #2 of the first user device.

Usually, a conditional controlling message is expressed in a natural language: “If readState #2 is in a low range, then SetState #1(value #1).”, In general, an actuation action is in a condition of the result of an observation action. In order to support a condition, a condition description is added to an observation function modality besides API name, list of arguments, and description. In the example of: “If readState #2 is in a low range, then SetState #1(value #1).”, a first condition description would be “If the checked state #2 is in a low range” in a natural language and its correspondent API would be “readState #2( )<=low-range-upbound”. Also, a second condition description could be “If the checked state #2 is in a high range” in a natural language and its correspondent API would be “readState #2( )>=high-range-low-bound”.

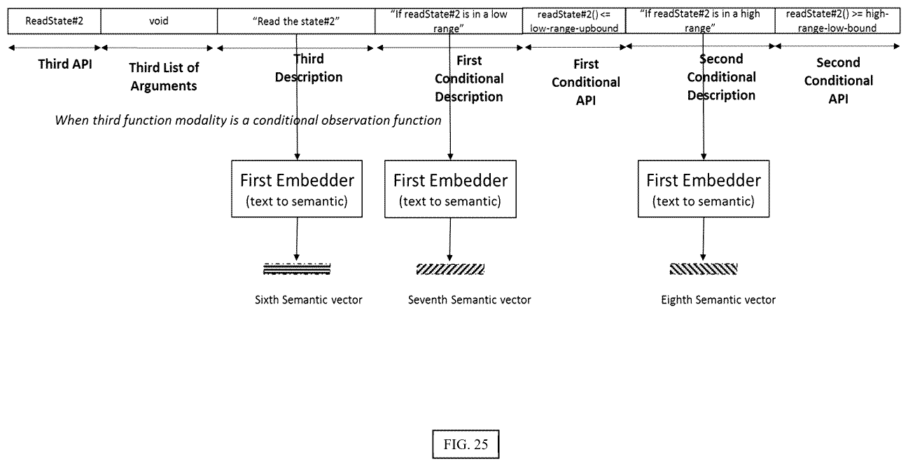

When the first user device registers an observation function modality (for example the third function modality), the first user needs to send the third description of the third function modality to the central device, but also the first (and second) condition description to the central device. As illustrated in FIG. 25, the first user device may use the first embedder to translate the third description into a sixth semantic vector (or a batch of sixth semantic vectors with different lengths) and then store it. The first user device may use the first embedder to translate the first condition description of the third function modality into a seventh semantic vector (or a batch of seventh semantic vectors with different lengths) and then store it. The first user device may use the first embedder to translate the second condition description of the third function modality into an eighth semantic vector (or a batch of seventh semantic vectors with different lengths) and then store it.

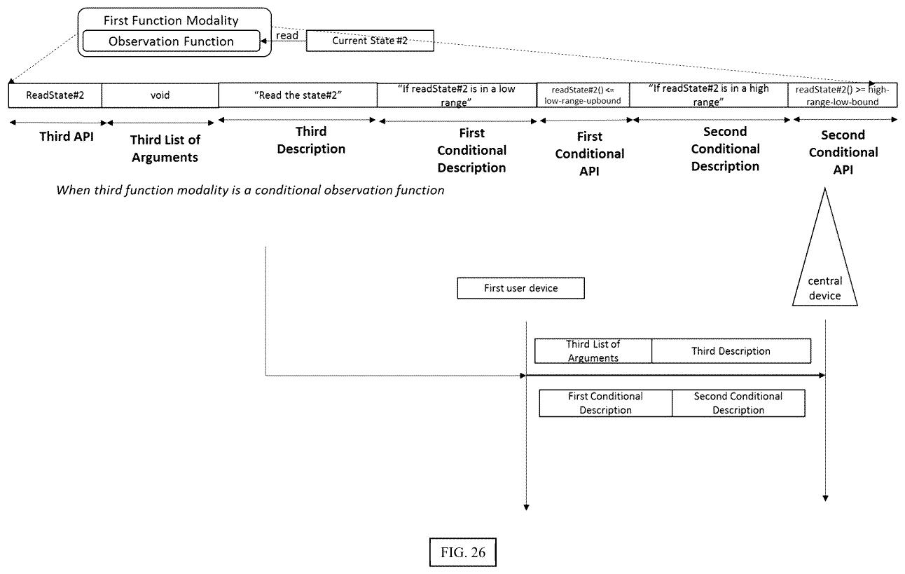

As illustrated in FIG. 26, the first user device sends the third list of arguments, third description (in natural language), first conditional description (in a natural language), and second conditional description (in a natural language) to the central device.

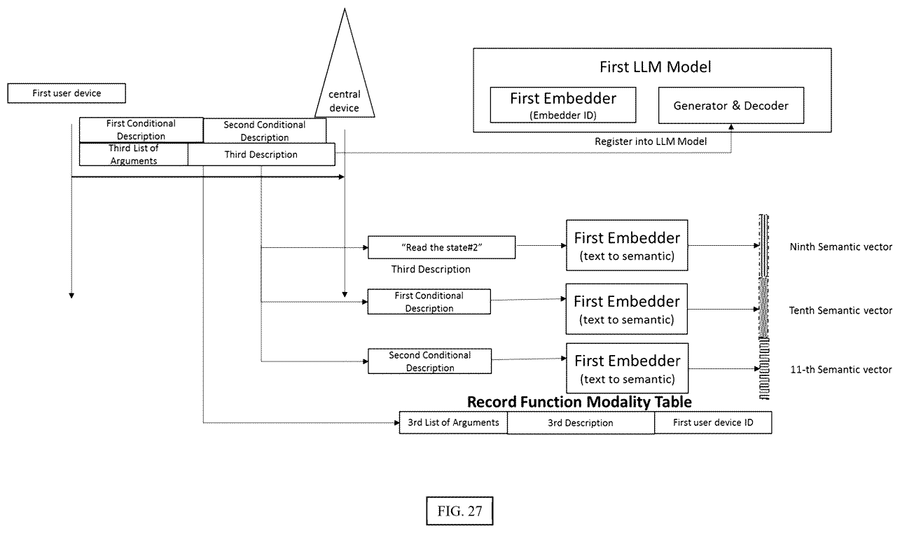

As illustrated in FIG. 27, after receiving the 3rd description and the 3rd list of arguments, the central device may register the 3rd function modality into the first LLM model by providing the 3rd description, the first conditional description, the second conditional description, and the 3rd list of arguments. Optionally, the central device may register the 3rd function modality into the second LLM model by providing the 3rd description, the first conditional description, the second conditional description, and the 3rd list of arguments, if there is the second LLM model.

Optionally, the central device may use the first embedder to translate the 3rd description into a 9-th semantic vector (or a 9-th batch of semantic vectors with different lengths), and then store it. The central device may use the first embedder to translate the 1st conditional description into a 10-th semantic vector (or a 10-th batch of semantic vectors with different lengths), and then store it. The central device may use the first embedder to translate the 2nd conditional description into a 11-th semantic vector (or a 9-th batch of semantic vectors with different lengths), and then store it.

### Translating Conditional Open-Vocabulary Controlling Message(s)

The central device uses the first LLM model to generate at least a first conditional open-vocabulary controlling message. The first conditional controlling message in natural language may include a list of arguments (values) and is targeted at the first function modality (an actuation action) on the first user device on the condition on the result of third function modality on the first device. For example, the first conditional open-vocabulary controlling message is “if the checked out state #2 is in a low range, then configure the state #1 as value 1.”. Often, a “if . . . then” can be used as prompt for language generator to generate a conditional controlling message.

Just as the first open-vocabulary controlling message in FIG. 19, the central device may divide the first conditional open-vocabulary controlling message into two parts and translate the second part into the fifth semantic vector.

### Encoding and Transmitting Conditional Open-Vocabulary Controlling Message(s)

The central device may encode and transmit the first conditional open-vocabulary controlling message very similar as the first open-vocabulary controlling message to the first user as FIG. 20.

### Understanding Open-Vocabulary Controlling Messages

The first user device receives and processes the received the first conditional open-vocabulary controlling message very similar as the first open-vocabulary controlling message in FIG. 21.

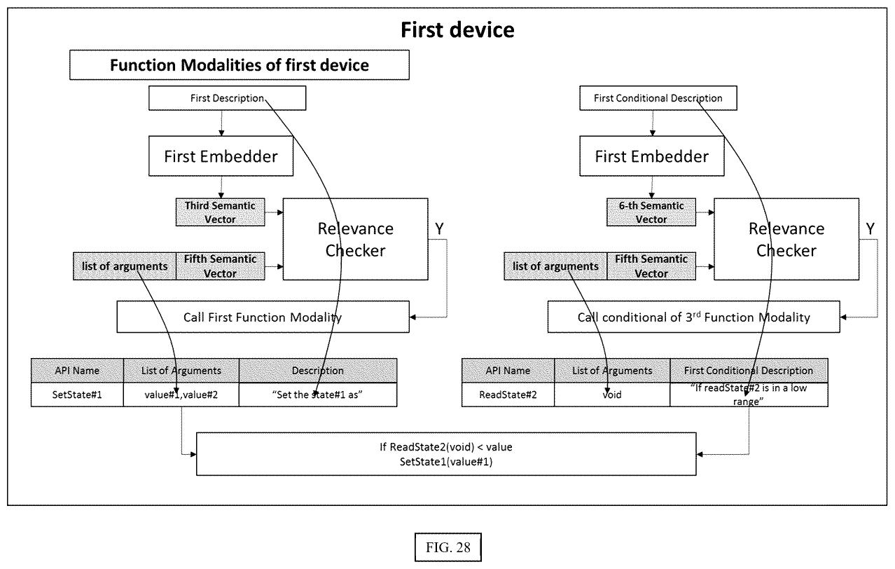

Unlike processing the first open-vocabulary controlling messages as in FIG. 22, the first user may compute the relevance between the fifth semantic and all its candidate semantic that includes at least the first semantic vector, and the 6-th semantic vector, and the 7-th semantic vector. The first user device may select the first semantic and 7-th semantic vector as the most relevant to the fifth semantic. Then, the first user device may call the first API calling function with the arguments that the first user device decodes in the first transmission opportunity in the condition of the result of the first conditional API of the 3rd function modality, as illustrated in FIG. 28.

### Registering a Looping Function Modality

Like a conditional functional modality, an observation function modality can become a condition for a loop for a number of actuation function modalities.

Exactly as supporting a conditional description on an observation function modality, the first user device can add a looping description in a natural language. For example, “while checked state #2 is in a low range” and “while checked state #2 is in a high range”.

From FIG. 24 to FIG. 28, all the conditional descriptions can be replaced by loop descriptions. The first LLM model of the central device may generate the first looping open vocabulary controlling message by a prompt such as “while . . . , do . . . ”.

### Programming a User Device by a Sequence of Open-Vocabulary Controlling Messages

After the first user device and the central device support the first open-vocabulary controlling message, the first conditional open-vocabulary controlling message, and the first looping open-vocabulary controlling message, the central device may use the first LLM model to generate a sequence or chain of open-vocabulary controlling messages to program the first user device.

As the orders of instructions matter in a program, the order of the sequence of open-vocabulary controlling messages matter too. For example, the central device may generate a sequence as:
Message 1: If checked state 2 is in a low range, then configure the state #1 as value #1;
Message 2: while checked state 1 is in a high range, set the state 3 as value #2.

Message 1 shall be executed before Message 2. It means that the first user device cannot execute the Message 2 until the Message 1 is done. Or if the first user device is unable to decode, understand, or execute the Message 1, it doesn't need to decode the Message #2.

### Registering a Customer's Function Modality

A customer's function modality is not standardized. It is more likely that the customer's function modality is black box as well. Therefore, unlike a wireless-related function modality as in FIG. 14, its API function is not available to the (wireless) system. Moreover, the description of the function is not available either.

In this disclosure, the first user device supports a “black-box” customer's function modality called as 4-th function modality. Unlike the first, second, and third modality functions, the first user device doesn't transmit the description (4-th description) of the 4-th function modality to the central device. The first user device uses the first embedder to translate the 4-th description into a 12-th semantic vector (or a 12-th batch of semantic vectors with different lengths), and then store it.

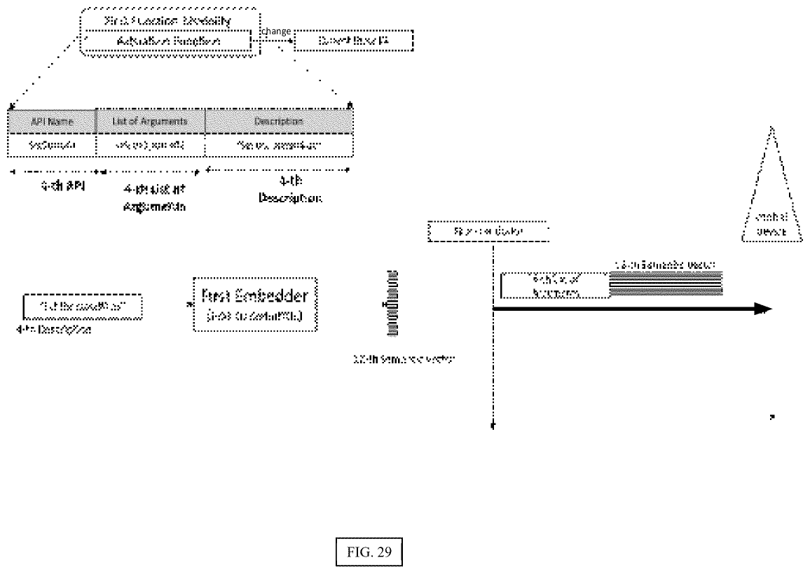

As illustrated in FIG. 29, the first user device transmits the 4-th list of arguments of the 4-th function modality and the 12-th semantic vector to the central device. (In comparison in FIG. 19, the first user device transmits the first list of arguments and first description in a natural language to the central device.)

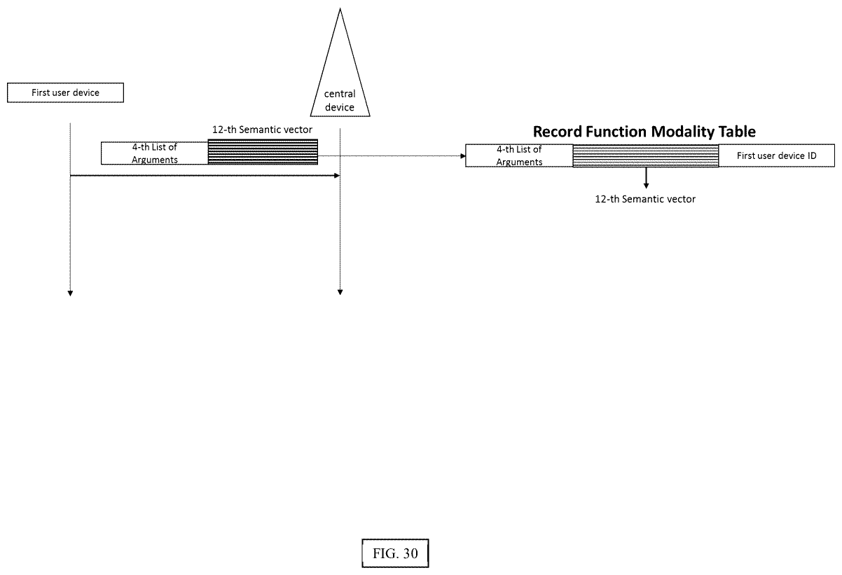

As illustrated in FIG. 30, after the central device receives the 4-th list of argument and the 12-th semantic vector, it would store the 12-th semantic vector and record the 12-th semantic vector associated to the first user device identifier. It is assumed that the customer has already register the 4-th function modality and the 4-th description into the first LLM model.

### Translating Open-Vocabulary Controlling Message(s)

The central device uses the first LLM model to generate at least a first customer open-vocabulary controlling message. The first customer controlling message in natural language may include a list of arguments (values) and is targeted at the 4-th function modality on the first user device.

The central device may encode and transmit the first customer open-vocabulary controlling message very similar as the first open-vocabulary controlling message to the first user as FIG. 19 and FIG. 20. Although the checking in FIG. 20 is optional, the central device needs to check the relevance as FIG. 20 between the 5-th semantic vector and the stored 12-th semantic vector. If the relevance is true, the central device can know to which user device (the first user device for example) to transmit the 5-th semantic vector.

### Understanding Open-Vocabulary Controlling Messages

The first user device receives and processes the received the first conditional open-vocabulary controlling message very similar as the first open-vocabulary controlling message in FIG. 21.

Unlike processing the first open-vocabulary controlling messages as in FIG. 22, the first user may compute the relevance between the fifth semantic and all its candidate semantic that includes at least the 12-th semantic vector. The first user device may select the 12-th semantic vector as the most relevant to the fifth semantic. Then, the first user device may call the 4-th API calling function with the arguments that the first user device decodes in the first transmission opportunity.

Moreover, the 4-th function modality can be unconditional one, conditional one, and loop one. The methods designed for conditional controlling message and looping controlling message can be applied to customer's conditional controlling message and customer's looping controlling message.

Similarly, the central device may use a sequence of customer's controlling messages to program the first user device.

Please note that, for V2X scenario, the DCI may be replayed by SCI, DCI field bundle may be replaced by SCI field bundle.

Please not that in the disclosure, “controlling message”, “control message” and “control signaling” could be used exchangeable with same meaning.

Please note that in this disclosure, “message” could represent “information”, or carry “information”. In some aspects of the present disclosure, there is provided a computer program comprising instructions. The instructions, when executed by a processor, may cause the processor to implement the method of the present disclosure.

Next, embodiments of products related to the wireless communication methods will be described.

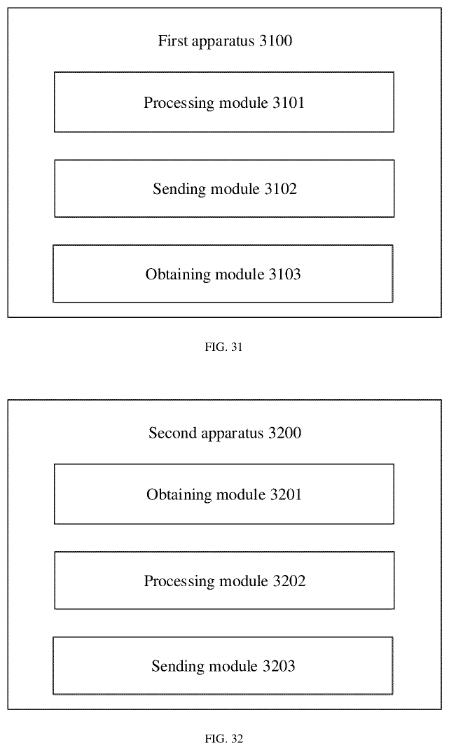

FIG. 31 shows a schematic structural diagram of a first apparatus according to one or more example embodiments of the present disclosure. The first apparatus may be applied to the central device described above, or installed in or applied to a chip in the central device or any other equipment, module, circuit or unit that can implement the steps of the central device in above method embodiments. As shown in FIG. 31, a first apparatus 3100 may include:
a processing module 3101, configured to:
generate a controlling message in natural language by using a language model (LM);
obtain semantic information of the controlling message according to the controlling message;
form an information payload when the semantic information of the controlling message is relevant to one or more pieces of multiple pieces of semantic information, where the multiple pieces of semantic information correspond to multiple function modalities that have been registered to the LM, and a part or all of the multiple pieces of semantic information is obtained from at least one user device, and where the information payload includes the semantic information of the controlling message;
a sending module 3102, configured to send the information payload.

In a possible implementation, the LM may be a language learning model (LLM).

In a possible implementation, the first apparatus 3100 further includes an obtaining module 3103, configured to: obtain registering information of a function modality, where the registering information includes one or more pieces of semantic information of the function modality, where the function modality belongs to the multiple function modalities.

In a possible implementation, the one or more pieces semantic information of the function modality include a piece of semantic information obtained from a description of the function modality, where the description of the function modality is in natural language.

In a possible implementation, the one or more pieces of semantic information of the function modality further include at least one piece of semantic information relevant to a result of the function modality, where the at least one piece of semantic information relevant to the result of the function modality is obtained from at least one description relevant to the result of the function modality and the at least one description relevant to the result of the function modality is in natural language.

In a possible implementation, the registering information of the function modality further includes a list of arguments of the function modality.

In a possible implementation, the processing module 3101 is further configured to:
record the registering information of the function modality.

In a possible implementation, the processing module 3101 is further configured to:
record information indicative of a user device identifier (ID) or a group user device ID of a user device from which the registering information of the function modality is received.

In a possible implementation, the processing module 3101 is further configured to:
reject the controlling message, when the relevance between the semantic information of the controlling message and each of the multiple pieces of semantic information is lower than a threshold.

In a possible implementation, the controlling message indicates an action to be executed.

In a possible implementation, the controlling message further indicates information related to execution of the action indicated by the controlling message.

In a possible implementation, the controlling message is a conditional controlling message or a looping controlling message.

In a possible implementation, the information related to the execution of the action is based on a result of another action indicated by the controlling message.

In a possible implementation, the multiple pieces of semantic information corresponding to the multiple function modalities that have been registered to the LM include multiple pieces of first semantic information each corresponding to a respective function modality in the multiple function modalities and obtained from a description of the respective function modality in the multiple function modalities.

In a possible implementation, the multiple pieces of semantic information corresponding to the multiple function modalities further include at least one piece of second semantic information each obtained from a description relevant to a result of a function modality in the multiple function modalities.

In a possible implementation, the processing module 3101 is further configured to:
determine a portion without any arguments from the controlling message;
obtain the semantic information of the controlling message by using an embedder and according to the portion.

In a possible implementation, the processing module 3101 is further configured to:
form a first information payload, where the first information payload includes starting position information of a second transmission opportunity and length information of the semantic information of the controlling message; and
form a second information payload, where the second information payload includes the semantic information of the controlling message, and where the second transmission opportunity is for transmission of the second information payload information.

In a possible implementation, the controlling message further includes a list of arguments, and the first information payload further includes the list of arguments of the controlling message.

In a possible implementation, the processing module 3101 is further configured to:
encode the second information payload by using a first encoding method;
where the first information payload further includes information of the first encoding method.

In a possible implementation, the processing module 3101 is further configured to:
encode the first information payload by using a second encoding method.

In a possible implementation, the first encoding method includes a first modulation and coding scheme (MCS), and the second encoding method includes a second MCS.

In a possible implementation, the processing module 3101 is further configured to:
determine one or more pieces of semantic information most relevant to the semantic information of the controlling message from the multiple pieces of semantic information corresponding to the multiple function modalities that have been registered, and according to the relevance between the semantic information of the controlling message and each of the multiple pieces of semantic information corresponding to the multiple function modalities that have been registered; and
determine at least one user device ID or at least one group user device ID corresponding to the one or more pieces of most relevant semantic information;
where the first information payload further includes: the at least one user device ID, or at least one group user device ID; or the first information payload further includes information indicative of the at least one user device ID or information indicative of the at least one group user device ID.

In a possible implementation, the sending module 3102 is configured to:
send the first information payload during a first transmission opportunity; and
send the second information payload during the second transmission opportunity.

In a possible implementation, the sending module 3102 is further configured to:
send configuration information of at least one embedder.

In a possible implementation, the configuration information of the at least one embedder is sent via a broadcast message, a multicast message, or a unicast message.

In a possible implementation, the configuration information of the at least one embedder includes an architecture and parameters of each of the at least one embedder.

In a possible implementation, the configuration information of the at least one embedder further includes an embedder ID of each of the at least one embedder.

In a possible implementation, the first information payload further includes: information indicative of an embedder ID of an embedder used to obtain the semantic information of the controlling message.

In a possible implementation, the information payload is sent via a multicast message or a unicast message.

FIG. 32 shows a schematic structural diagram of a second apparatus according to one or more example embodiments of the present disclosure. The second apparatus may be applied to the user device described above, or installed in or applied to a chip in the central device or any other equipment, module, circuit or unit that can implement the steps of the user device in above method embodiments. As shown in FIG. 32, a second apparatus 3200 may include:
an obtaining module 3201, configured to obtain an information payload, where the information payload includes semantic information of a controlling message, where the semantic information of the controlling message is relevant to one or more pieces of semantic information in multiple pieces of semantic information, and the multiple pieces of semantic information correspond to multiple function modalities that have been registered to a language model (LM) generating the controlling message, and a part or all of the multiple pieces of semantic information is obtained from at least one user device;
a processing module 3202, configured to:
determine target semantic information according to the semantic information of the controlling message and from multiple pieces of candidate semantic information, where the multiple pieces of candidate semantic information correspond to multiple function modalities that are supported by a user device, and the target semantic information indicates a function modality to be executed, and the multiple function modalities that are supported by the user device includes the function modality to be executed; and
execute the function modality to be executed according to the target semantic information.

In a possible implementation, the LM may be an LLM.

In a possible implementation, the second apparatus further includes a sending module 3203, configured to:
send multiple pieces of registering information of the multiple function modalities, wherein at least one piece of registering information each includes one or more pieces of semantic information of a corresponding function modality, wherein the multiple pieces of registering information include the at least one piece of registering information.

In a possible implementation, the one or more pieces of semantic information of the corresponding function modality include a piece of semantic information obtained from a description of the corresponding function modality, wherein the description of the corresponding function modality is in natural language.

In a possible implementation, the one or more pieces of semantic information of the corresponding function modality further include at least one piece of semantic information relevant to a result of the corresponding function modality, wherein the at least one piece of semantic information relevant to the result of the corresponding function modality is obtained from at least one description relevant to the result of the corresponding function modality, and the at least one description relevant to the result of the function modality is in natural language.

In a possible implementation, each of one or more pieces of registering information includes a list of arguments of a corresponding function modality, wherein the multiple pieces of registering information include the one or more pieces of registering information.

In a possible implementation, the processing module 3202 is configured to:
determine at least one piece of candidate semantic information most relevant to the semantic information of the controlling message from the multiple pieces of candidate semantic information as the target semantic information.

In a possible implementation, the target semantic information further indicates information related to execution of the function modality.

In a possible implementation, the controlling message is a conditional controlling message or a looping controlling message.

In a possible implementation, the information related to the execution of the function modality is based on a result of another function modality as indicated by the controlling message.

In a possible implementation, the processing module 3202 is configured to:
encapsulate each of the multiple function modalities that are supported by the user device in a calling function to obtain multiple calling functions, wherein each of the multiple calling functions includes a description of a respective function modality, wherein the description is in natural language.

In a possible implementation, one or more calling functions of the multiple calling functions each further include at least one of: a list of arguments of the respective function modality or at least one description relevant to a result of the respective function modality, wherein the at least one description relevant to the result of the function modality is in natural language, and includes a conditional description describing a condition on the result of the respective function modality, or a looping description describing a loop with a condition on the result of the respective function modality.

In a possible implementation, the calling function includes an application programming interface (API) calling function.

In a possible implementation, the obtaining module 3201 is configured to:
obtain configuration information of at least one embedder.

In a possible implementation, the configuration information of the at least one embedder includes an architecture and parameters of each of the at least one embedder.

In a possible implementation, the configuration information of the at least one embedder further includes an embedder ID of each of the at least one embedder.

In a possible implementation, the processing module 3202 is configured to:
obtain, by using the at least one embedder, one or more pieces of semantic information for each function modality of the multiple function modalities that are supported by the user device; and
store the one or more pieces of semantic information.

In a possible implementation, the one or more pieces of semantic information for each function modality includes a piece of semantic information obtained from a description of each function modality.

In a possible implementation, the one or more pieces of semantic information for each of one or more function modalities further includes at least one piece of semantic information obtained from at least one description relevant to a result of a corresponding function modality, wherein the multiple function modalities include the one or more function modalities.

In a possible implementation, the processing module 3202 is configured to decode the information payload.

In a possible implementation, the information payload includes:
a first information payload, obtained during a first transmission opportunity, and including starting position information of a second transmission opportunity and length information of the semantic information of the controlling message; and
a second information payload, obtained during the second transmission opportunity, and including the semantic information of the controlling message.

In a possible implementation, the processing module 3202 is configured to:
decode the first information payload to obtain the starting position information of the second transmission opportunity and the length information of the semantic information of the controlling message; and
decode the second information payload to obtain the semantic information of the controlling message.

In a possible implementation, the first information payload further includes: a list of arguments of the controlling message.

In a possible implementation, the first information payload further includes information of a first encoding method, and the second information payload is decoded by using the first encoding method.

In a possible implementation, the first information payload is decoded by using a second encoding method.

In a possible implementation, the first encoding method includes a first modulation and coding scheme (MCS), and the second encoding method include a second MCS.

In a possible implementation, the first information payload further includes information indicative of the embedder ID of a first embedder, and wherein the processing module 3202 is configured to:
obtain the multiple pieces of candidate semantic information from the stored one or more pieces of semantic information and according to the information indicative of the embedder ID of the first embedder.

In a possible implementation, the first information payload further includes: information indicative of a user device ID or information indicative of a group user device ID.

In a possible implementation, the processing module 3202 is configured to:
in response to determining that the user device ID or the group user device ID does not match a user device ID or a group user device ID of the user device, refrain from decoding the second information payload.

An embodiment of the present disclosure provides a third apparatus including processing circuitry for executing any of the above communication methods performed by the central device. It should be understood that the third apparatus can execute the steps performed by the central device in the above method embodiments, which will not be repeated here.

An embodiment of the present disclosure provides a fourth apparatus including processing circuitry for executing any of the above communication methods performed by the user device. It should be understood that the fourth apparatus can execute the steps performed by the user device in the above method embodiments, which will not be repeated here.

An embodiment of the present disclosure provides a communication system which includes at least one first apparatus and/or at least one third apparatus described above, at least one second apparatus and/or at least one fourth apparatus described above, and at least one third apparatus and/or at least one sixth apparatus described above.

An embodiment of the present disclosure provides a communication system, including at least one first processing circuitry and at least one second processing circuitry. The first processing circuitry is configured to execute the steps executed by the central device in any of the above communication methods, and the second processing circuitry is configured to execute the steps executed by the user device in any of the above communication methods.

An embodiment of the present disclosure provides a computer-readable medium storing computer execution instructions which, when executed by a processor, causes the processor to execute the steps performed by the central device or the steps performed by the user device in any of the above communication methods.

An embodiment of the present disclosure provides a computer program product including computer execution instructions which, when executed by a processor, causes the processor to execute the steps performed by the central device or the steps performed by the user device in any of the above communication methods.

Although embodiments of the present disclosure describes methods and processes with steps in a certain order, one or more steps of the methods and processes may be omitted or altered as appropriate. One or more steps may take place in an order other than that in which they are described, as appropriate.

In some aspects of the present disclosure, there is provided a non-transitory computer-readable medium storing instructions, the instructions, when executed by a processor, may cause the processor to implement the method of the present disclosure.

In some aspects of the present disclosure, there is provided an apparatus/chipset system comprising means to implement the method implemented by the sensing device of the present disclosure.

In some aspects of the present disclosure, there is provided an apparatus/chipset system comprising means to implement the method implemented by the central device of the present disclosure.

In some aspects of the present disclosure, there is provided an apparatus/chipset system comprising means to implement the method implemented by the GPT device of the present disclosure.

In some aspects of the present disclosure, there is provided a system comprising at least two of an apparatus in the sensing device of the present disclosure, an apparatus in the central device of the present disclosure and an apparatus in the GPT device of the present disclosure.

In some aspects of the present disclosure, there is provided an apparatus/chipset system comprising at least one processor executing instructions stored in a computer-readable medium to implement the method implemented by the sensing device of the present disclosure.

In some aspects of the present disclosure, there is provided an apparatus/chipset system comprising at least one processor executing instructions stored in a computer-readable medium to implement the method implemented by the central device of the present disclosure.

In some aspects of the present disclosure, there is provided an apparatus/chipset system comprising at least one processor executing instructions stored in a computer-readable medium to implement the method implemented by the GPT device of the present disclosure.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

What is claimed is:

1. A method, comprising:
generating, by using a language model (LM), a controlling message in natural language;
obtaining, according to the controlling message, semantic information of the controlling message;
forming an information payload when the semantic information of the controlling message is relevant to one or more pieces of multiple pieces of semantic information, wherein the multiple pieces of semantic information correspond to multiple function modalities that have been registered to the LM, and a part or all of the multiple pieces of semantic information is obtained from at least one user device, and wherein the information payload comprises the semantic information of the controlling message;
sending the information payload.

2. The method according to claim 1, further comprising:
obtaining registering information of a function modality, wherein the registering information comprises one or more pieces of semantic information of the function modality, wherein the function modality is comprised in the multiple function modalities.

3. The method according to claim 2, wherein the one or more pieces of semantic information of the function modality comprise a piece of semantic information obtained from a description of the function modality, wherein the description of the function modality is in the natural language.

4. The method according to claim 3, wherein the one or more pieces of semantic information of the function modality further comprise at least one piece of semantic information relevant to a result of the function modality, wherein the at least one piece of semantic information relevant to the result of the function modality is obtained from at least one description relevant to the result of the function modality, and the at least one description relevant to the result of the function modality is in the natural language.

5. The method according to claim 2, wherein the registering information of the function modality further comprises a list of arguments of the function modality.

6. The method according to claim 2, further comprising at least one of:
recording the registering information of the function modality; or
recording information indicative of a user device identifier (ID) or a group user device ID of a user device from which the registering information of the function modality is received.

7. An apparatus, comprising:
at least one processor coupled with a non-transitory computer readable memory storing instructions, where when the instructions are executed by the at least one processor, the apparatus is caused to:
generate a controlling message in natural language by using a language model (LM);
obtain semantic information of the controlling message according to the controlling message;
form an information payload when the semantic information of the controlling message is relevant to one or more pieces of multiple pieces of semantic information, wherein the multiple pieces of semantic information correspond to multiple function modalities that have been registered to the LM, and a part or all of the multiple pieces of semantic information is obtained from at least one user device, and wherein the information payload comprises the semantic information of the controlling message; and
send the information payload.

8. The apparatus according to claim 7, wherein when the instructions are executed by the at least one processor, the apparatus is further caused to:
obtain registering information of a function modality, wherein the registering information comprises one or more pieces of semantic information of the function modality, and wherein the function modality is comprised in the multiple function modalities.

9. The apparatus according to claim 8, wherein the one or more pieces semantic information of the function modality comprise a piece of semantic information obtained from a description of the function modality, wherein the description of the function modality is in the natural language.

10. The apparatus according to claim 9, wherein the one or more pieces of semantic information of the function modality further comprise at least one piece of semantic information relevant to a result of the function modality, wherein the at least one piece of semantic information relevant to the result of the function modality is obtained from at least one description relevant to the result of the function modality, and the at least one description relevant to the result of the function modality is in the natural language.

11. The apparatus according to claim 8, wherein the registering information of the function modality further comprises a list of arguments of the function modality.

12. The apparatus according to claim 8, wherein the when the instructions are executed by the at least one processor, the apparatus is further caused to:
record the registering information of the function modality; or
record information indicative of a user device identifier (ID) or a group user device ID of a user device from which the registering information of the function modality is received.

13. The apparatus according to claim 7, wherein when the instructions are executed by the at least one processor, the apparatus is further caused to:
reject the controlling message when the relevance between the semantic information of the controlling message and each of the multiple pieces of semantic information is lower than a threshold.

14. An apparatus, comprising:
at least one processor coupled with a non-transitory computer readable memory storing instructions, where when the instructions are executed by the at least one processor, the apparatus is caused to:
obtain an information payload, wherein the information payload comprises semantic information of a controlling message, wherein the semantic information of the controlling message is relevant to one or more pieces of semantic information in multiple pieces of semantic information, and the multiple pieces of semantic information correspond to multiple function modalities that have been registered to a language model (LM) generating the controlling message, and a part or all of the multiple pieces of semantic information is obtained from at least one user device;
determine target semantic information according to the semantic information of the controlling message, and from multiple pieces of candidate semantic information, wherein the multiple pieces of candidate semantic information correspond to multiple function modalities that are supported by a user device, and the target semantic information indicates a function modality to be executed, and the multiple function modalities that are supported by the user device comprises the function modality to be executed; and
execute the function modality to be executed according to the target semantic information.

15. The apparatus according to claim 14, when the instructions are executed by the at least one processor, the apparatus is further caused to:
send multiple pieces of registering information of the multiple function modalities, wherein each of at least one piece of registering information of the multiple pieces of registering information comprises one or more pieces of semantic information of a corresponding function modality, and wherein the multiple pieces of registering information comprise each of the at least one piece of registering information.

16. The apparatus according to claim 15, wherein each one or more pieces of semantic information of the corresponding function modality comprises a piece of semantic information obtained from a description of the corresponding function modality, wherein the description of the corresponding function modality is in the natural language.

17. The apparatus according to claim 16, wherein each one or more pieces of semantic information of the corresponding function modality further comprises at least one piece of semantic information relevant to a result of the corresponding function modality, wherein the at least one piece of semantic information relevant to the result of the corresponding function modality is obtained from at least one description relevant to the result of the corresponding function modality, and the at least one description relevant to the result of the function modality is in the natural language.

18. The apparatus according to claim 15, wherein each of one or more pieces of registering information comprises a list of arguments of a corresponding function modality, wherein the multiple pieces of registering information comprise the one or more pieces of registering information.

19. The apparatus according to claim 14, wherein when the instructions are executed by the at least one processor, the apparatus is further caused to:
determine at least one piece of candidate semantic information most relevant to the semantic information of the controlling message from the multiple pieces of candidate semantic information as the target semantic information.

20. The apparatus according to claim 14, wherein the target semantic information further indicates information related to execution of the function modality.
